(19) United States
(12) Patent Application Publication
(10) Pub. No.: US 2015/0074009 A1
(43) Pub. Date: Mar. 12, 2015

(54) SYSTEM AND METHOD FOR AUTOMATED TRAINING, CERTIFICATION AND RECORDATION FOR CLIMBER/TOWER SAFETY AND REGULATORY COMPLIANCE AT COMMUNICATIONS SITES

(71) Applicant: RF Check, Inc., Del Mar, CA (US)

(72) Inventor: Douglas M. Williams, Del Mar, CA (US)

(21) Appl. No.: 14/542,500

(22) Filed: Nov. 14, 2014

Related U.S. Application Data
(63) Continuation-in-part of application No. 13/933,966, filed on Jul. 2, 2013.
Application No. 13/933,966 is a continuation-in-part of application No. 12/023,901, filed on Jan. 31, 2008, now Pat. No. 8,583,446.
Application No. 12/023,901 is a continuation-in-part of application No. 11/394,555, filed on Mar. 31, 2006, now Pat. No. 7,570,922.
Application No. 11/394,555 is a continuation-in-part of application No. 11/100,947, filed on Apr. 6, 2005, now abandoned.
Application No. 11/100,947 is a continuation-in-part of application No. 10/215,495, filed on Aug. 8, 2002, now abandoned.

(51) Int. Cl. G06Q 50/26; G06Q 10/00

(52) U.S. Cl. CPC G06Q 50/265; G06Q 10/00
USPC 705/325

(57) ABSTRACT

A computer based system for monitoring compliance of climber/tower safety procedures and personnel at communication towers. The system includes an updatable database of the wireless transmission towers and their unique safety information. The system can monitor and automatically generate reports of tower climber safety training and certification. Workers may be sorted by their employers, training status or other safety information including regulatory compliance. Communication towers may be sorted by structure type, safety status, type of work performed and who performed the work. The custom signs with the machine readable indicia can be used to enhance access to an automated climber/tower safety system.

### RELATED APPLICATIONS

This application is a continuation-in-part of U.S. application Ser. No. 13/933,966, filed Jul. 2, 2013, which is a continuation-in-part of U.S. application Ser. No. 12/023,901, filed Jan. 31, 2008 (now U.S. Pat. No. 8,583,446, issued Nov. 12, 2013), which is a continuation-in-part of U.S. application Ser. No. 11/394,555, filed Mar. 31, 2006 (now U.S. Pat. No. 7,570,922, issued Aug. 4, 2009), which is a continuation-in-part of U.S. application Ser. No. 11/100,947, filed Apr. 6, 2005, which is a continuation-in-part of U.S. application Ser. No. 10/215,495, filed Aug. 8, 2002; all of which are hereby incorporated by reference.

### FIELD OF THE INVENTION

This invention relates generally to climber/tower safety and more particularly to providing proper monitoring of communication tower climbing safety training.

### BACKGROUND

Since 2003 over 100 individuals have been killed and hundreds more injured while working on structural towers that mainly support the ever expanding wireless industry. This rate of fatalities is ten times that of the construction industry. The basis for the majority of these deaths and injuries can be directly attributed to the lack of meaningful safety provided to workers who often climb up several hundred feet before performing their assigned tasks.

The current systems for monitoring tower climber safety of field workers are inadequate and may often violate existing state and federal regulations. There are currently enormous cellular communications networks consisting of thousands of communication towers which are required to enable wireless services. Towers may require regular maintenance. Field workers undergo considerable risk when climbing the towers. State and federal regulations require field workers to complete training and properly utilize safety equipment in order to install antennas and other telecommunication equipment or provide maintenance on the towers.

The breakdown of climber/tower safety has several factors which contribute to these deaths and injuries: poor worker training, lack of proper field supervision, bravado by workers who ignore safety protocols and free-climb, business entities that place profit before safety, unrealistic construction deadlines demanded by wireless carriers, tower organizations and training companies with conflicting self-interests, and lack of federal enforcement by OSHA due to budgetary restrictions.

Deficiencies in climber/tower safety become more apparent with increases in deaths and injuries. However, there presently does not exist a system to effectively monitor the training, performance and compliance of field workers at a particular site, a particular communication tower, or across multiple communication towers.

In addition, the current systems of protecting field workers from radio frequency (“RF”) exposure at radio transmission sites, such as towers, are also inadequate and often in violation of existing state and federal regulations. These wireless transmission sites come with an environmental hazard as they generate RF radiation. RF radiation (“RFR”) is tasteless, odorless and invisible, increasing the need for a comprehensive RF safety compliance program and an overall safety programs.

### SUMMARY

To reverse this long standing trend, a new paradigm of climber/tower safety must be implemented. In addition, such a system can also address RF safety. Major components of such a system can contain the following to be effective: a comprehensive centralized database system of all communications towers (governmental and commercial) in the nation that includes all pertinent information on work that is done on each tower, individual standardized training and certification programs for each entity within the tower ecosystem (e.g., carriers, turf vendors, tower owners, contractors, workers, etc.), a database that facilitates comprehensive reporting and tracking of all accidents and injuries on towers as well as any safety issues identified in the field that must be addressed, the ability to audit and record worker and company compliance with tower safety requirements, and a database that provides appropriate access to individual and company tower safety records to give employers proper oversight of those doing their work and to allow regulatory agencies easy access to the information to facilitate enforcement.

Aspects of the present invention can include a computer based system which provides safety information related to tower climbing at a communication tower. The system may maintain a database of tower climbing related training certifications for individuals and/or companies. The system may provide instantaneous access to these certifications which can aid in monitoring proper safety procedures and personnel at any communication tower. Additionally, aspects provide for systems and methods which provide Climber/Tower Safety Certification and Site-specific Climber/Tower Safety Sheets. The system also provides for tracking accidents by personnel and companies as well as any safety violations or other pertinent safety anomalies by personnel and companies.

One aspect of this invention includes a safety system and method for managing and viewing information for communication towers. In one aspect the system includes a living database, indexed by tower, which includes characteristics of construction at thousands of communication towers obtained from a plurality of tower companies and wireless service providers. The system can be accessed on line through the World Wide Web network. The system also provides a record of what work was performed at the tower, when it was performed, and who performed it.

In one aspect, the system provides a computerized Site-specific Climber/Tower Safety Program. This Site-specific Climber/Tower Safety Program is automatically updated on a regular basis and/or when changes are made to a tower. The system has an automated safety audit program which runs periodically, for example, monthly and annually, to confirm that towers are in compliance with all relevant regulations, including international, Federal and State. The automated safety audit program generates compliance reports which can be date stamped and encrypted in order to meet regulatory record keeping requirements. These compliance reports can be provided to regulatory agencies to confirm compliance. The reports will also include the ultimate originator or owner of each job being performed in order to identify the responsible parties.

It should be understood that the invention is not limited only to communication towers, but also includes other structures such as other elevated structures including, for example, water tanks, buildings, faux trees, smokestacks, and any other wireless communication antenna site where workers are required to use fall protection equipment. Therefore, each reference herein to a tower or towers is equally applicable to other elevated structures such as water tanks, buildings, faux trees, smokestacks, and any other wireless communication antenna site where workers are required to use fall protection equipment.

Other features and advantages of the present invention should be apparent after reviewing the following detailed description and accompanying drawings which illustrate, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level block diagram illustrating an example network and the system.

FIG. 2 is a database diagram or schema illustrating an example of a tower's attributes.

FIG. 3A is a database diagram or schema illustrating the Tower Climbing Certification and Site-specific Climber/Tower Safety Sheet attributes.

FIG. 3B is a database diagram or schema illustrating the RF Certification and RF Safety Summary Sheet attributes.

FIG. 4 is a functional block diagram illustrating the functions or modules of one embodiment of the system.

FIG. 5 is a block diagram illustrating a controlled access to tower based on user's role in the system.

FIG. 6 is a flow diagram of one embodiment of the process implemented by the QR access function.

FIG. 7A is a flow diagram of the power down request functions.

FIG. 7B is a flow diagram of the functions performed once a power down request is sent to the wireless telecommunications company.

FIG. 8 is a flow diagram of one embodiment of the process implemented by the data update module.

FIG. 9 is a graphical representation of a physical site related to a generalized site data structure.

FIG. 10 is an example of tower plot map—a graphic representation of the communication tower and other tower elements tower plot view.

FIG. 11A is a block diagram representation of the Site-specific Climber/Tower Safety Summary Sheet.

FIG. 11B is a block diagram representation of the RF Safety Summary Sheet.

FIG. 12 is a flow diagram of one embodiment of an automated safety audit program.

FIGS. 13 and 14 are flow diagrams of one embodiment of the automated compliance audit program.

FIG. 15A is a flow diagram of functionality provided by the Climber/Tower Safety Certification module 427 of FIG. 4 which allows an employer to provide his employee with Site-specific Climber/Tower safety sheet.

FIG. 15B is a flow diagram of functionality provided by the RF certification module 429 of FIG. 4 which allows an employer to provide his employee with Site-specific RF safety summary Sheet.

FIG. 16A is a flow diagram of further functionality provided by the Climber/Tower Safety Certification module 427 of FIG. 4 which allows a user to provide contractor companies the system functionalities of tower access, training and certification similar to that provided for employees.

FIG. 16B is a flow diagram of further functionality provided by the RF Certification module 429 of FIG. 4 which allows a user to provide contractor companies the system functionalities of tower access, training and certification similar to that provided for employees.

FIG. 17A is a flow diagram of further functionality provided by the Climber/Tower Safety Certification module 427 of FIG. 4 which ensures a user's required Climber/Tower Safety Certification before starting to use the system.

FIG. 17B is a flow diagram of further functionality provided by the RF Certification module 429 of FIG. 4 which ensures a user's required Climber/Tower Safety Certification before starting to use the system.

FIG. 18A is a flow diagram of further functionality provided by the Climber/Tower Safety Certification module 427 of FIG. 4 which allows user to be CT certified upon his own request.

FIG. 18B is a flow diagram of further functionality provided by the RF Certification module 429 of FIG. 4 which allows user to be CT certified upon his own request.

FIG. 19A is a flow diagram of further functionality provided by the Climber/Tower Safety Certification module 427 of FIG. 4 and shows in details user's account activation including required Climber/Tower Safety Certification.

FIG. 19B is a flow diagram of further functionality provided by the RF Certification module 429 of FIG. 4 and shows in details user's account activation including required Climber/Tower Safety Certification.

### DETAILED DESCRIPTION

Certain embodiments as disclosed herein provide for systems and methods for automated training and certification for climber safety and regulatory compliance at communication towers and for enhancing access to an automated climber/tower safety system for communication towers (“System”). The systems and methods can also address RF safety. It should be understood that the invention is not limited only to communication towers, but also includes other structures such as other elevated structures including, for example, water tanks, buildings, faux trees, smokestacks, and any other wireless communication antenna site where workers are required to use fall protection equipment. Therefore, each reference herein to a tower or towers is equally applicable to other elevated structures such as water tanks, buildings, faux trees, smokestacks, and any other wireless communication antenna site where workers are required to use fall protection equipment. More generally, the locations of such structures are sometimes referred to herein as a “site” or “sites”.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

The present invention includes a method for using an information storage and retrieval system and includes establishing a database structure enabling the storage of information concerning the compliance of climber/tower safety certifications for communication towers such as those used in cellular telephone networks and for the commercial telecommunication industry. In some embodiments, the communication towers may be wireless radio frequency (RF) transmitting facilities (sometimes referred to as Sites). The system and methods provide Site-specific safety information and tools for monitoring compliance of workers and companies for climber/tower safety, provide enhanced on-site access to tower information, and provide auditing in order to document compliance with applicable regulations.

Electronic access to the information database can be made available over the Internet to the Systems' subscribers, referred to as “users” in this specification. The systems and methods described herein can provide greater worker safety, eliminate contract bidding disadvantages for safety oriented companies, and ensure compliance of all climber/tower safety standards. This allows for a level playing field for all tower climbing companies competing for business.

Additionally, workers and other users of the system can be provided a simplified access process to information for a tower which is identified by machine readable indicia which is read by a user device, for example, a cellular telephone. The machine readable indicia can be, for example, a matrix barcode (such as a QR (quick response) code). The QR code is preferably located at the tower on a sign warning of the fall hazard.

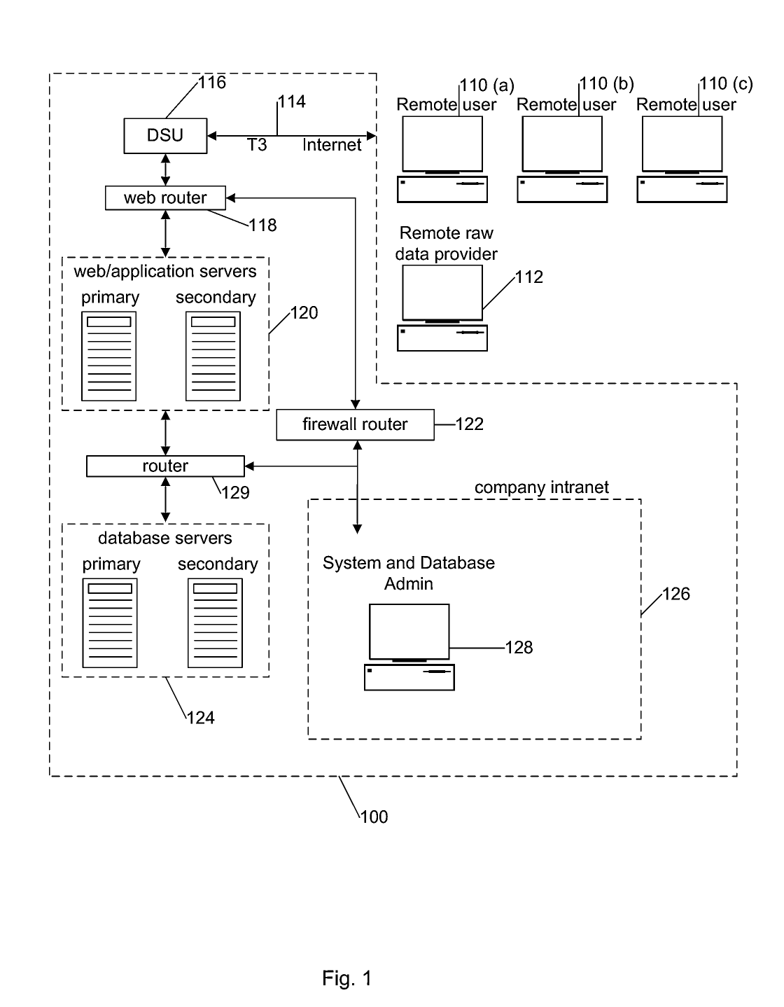

FIG. 1 is a high level block diagram of an example network including the System 100. The System 100 can communicate with users via an external network 114 such as the internet. Reference to a user or users herein refer to individuals interacting with the System 100 (and other embodiments described herein) via a computer interface. The computer interface can be directly with the System or via another computer or device which communicates with the System. As an example, the remote user devices 110a-c and a remote raw data provider device 112 are shown. Remote user devices include traditional computers, mobile computers, mobile telephones, smart phones and other mobile or fixed computing devices which can provide a user interface (e.g., a display an input mechanism) and access to the System via a network such as the internet. The System also includes a system and database administration module 128 within the company intranet 126 which can interact with the System directly. When communication traffic first enters the System 100 it passes through a data switch unit (“DSU”) 116. The traffic from the DSU is passed to a web router 118. From the web router the traffic flows to the web application servers 120. The web application servers in general, provide user interfaces. In one embodiment the web application servers include a primary load balanced application server and a back-up secondary server. The web application servers 120 communicate through a firewall router 122 with the database servers 124.

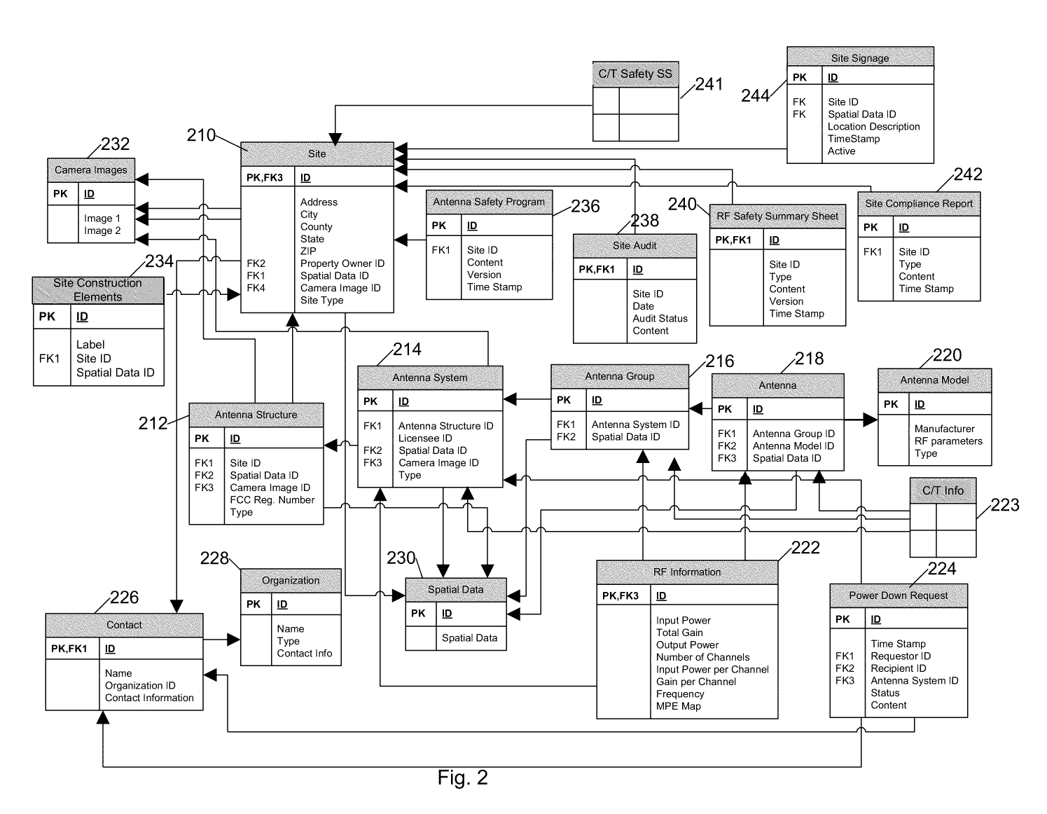

FIG. 2 is a database diagram or schema illustrating an example of a communication site database. The database can be implemented on the database servers 124 of FIG. 1. In one embodiment this technology is built on the Microsoft N-tier Distributed Network Architecture (“DNA”), which separates the database, data access, business logic, and presentation layers to provide security, scalability and performance for high volume database applications. The database includes multiple tables which each have resident information. In the embodiment depicted in FIG. 2, a subset of the database data is presented to illustrate the key elements of the system.

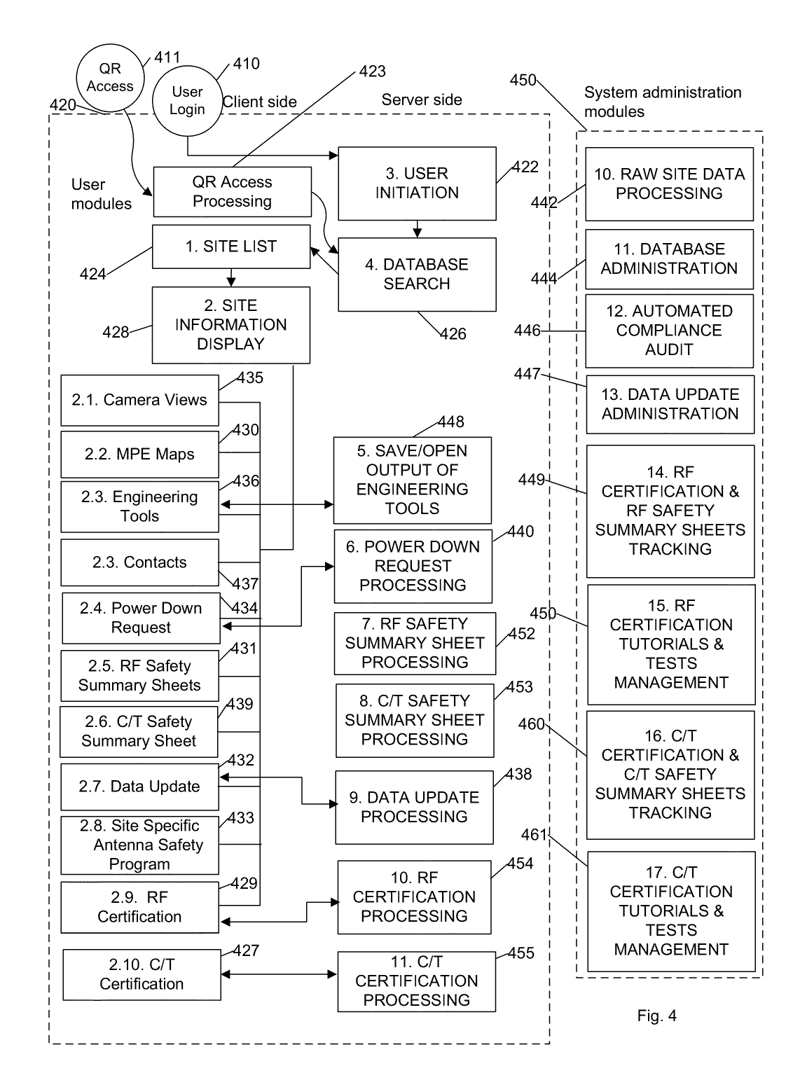

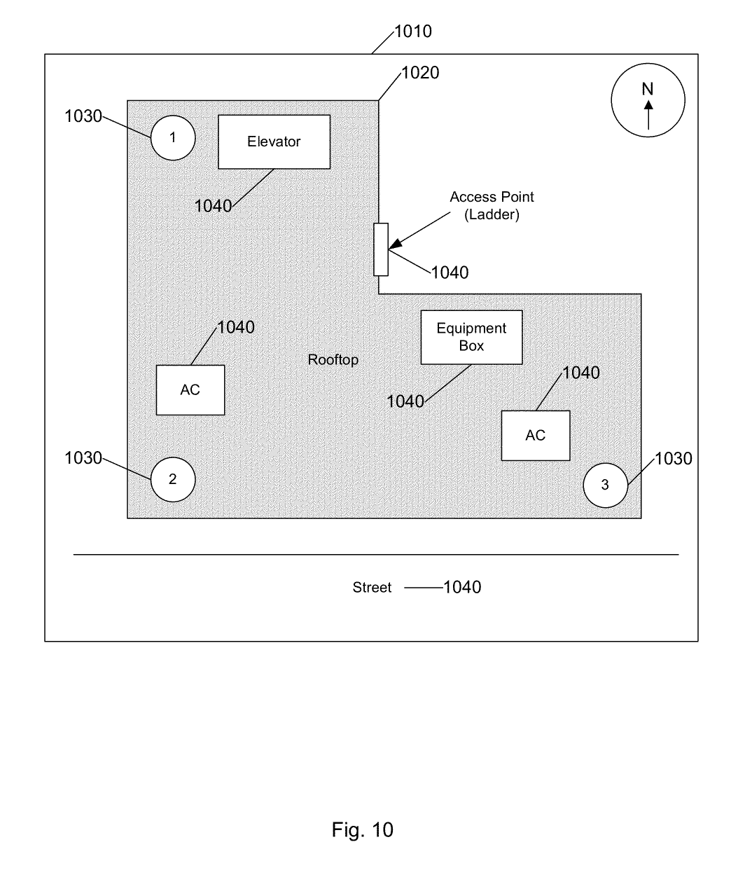

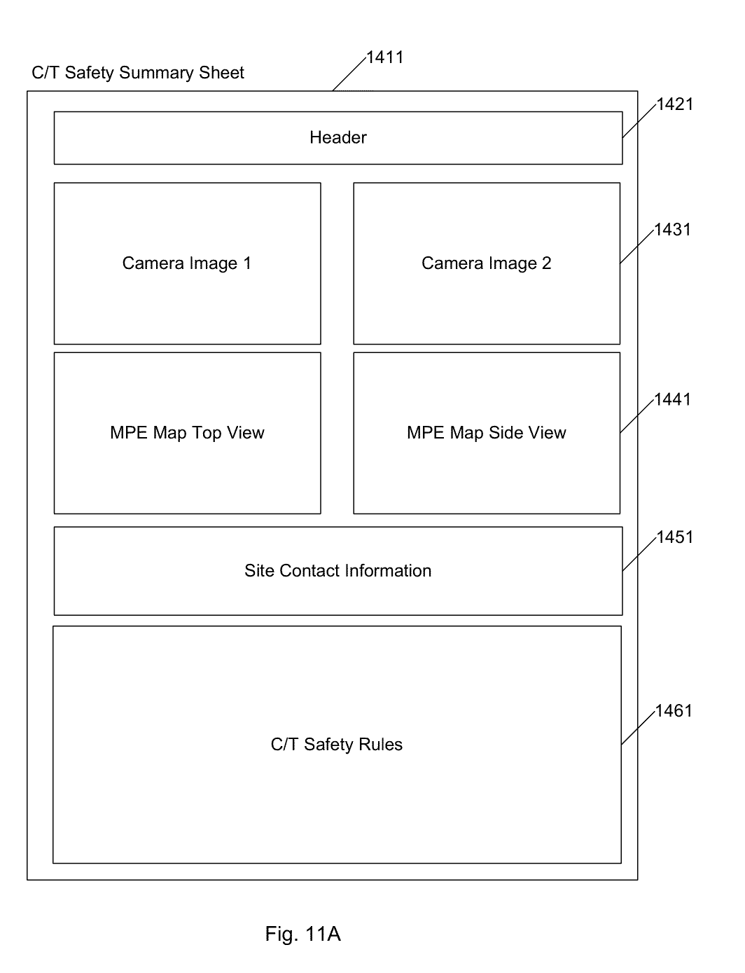

Site table 210 has following key attributes: ID which is a unique identifier for the site, including street Address, City, County, State and ZIP; Tower Operator ID which is associated with the Contact table 226 and identifies a operator; Spatial Data ID which is associated with the table Spatial Data 230 and identifies spatial data of the tower, which will explained in connection with FIGS. 9 and 10; Camera Image ID which is associated with table Camera Image 232 and identifies camera images used by module 435 of FIG. 4, which will be explained later; FCC Reg. Number which is an unique number assigned to tower by the Federal Communications Commission; Type identifies structure types. Tower Climbing Information table 223 stores the information used to determine the safety status of a tower. Antenna Structure table 212 has following key attributes: unique ID; Site ID which is associated with the table Site 210 and identifies the site which antenna structure was assigned to.

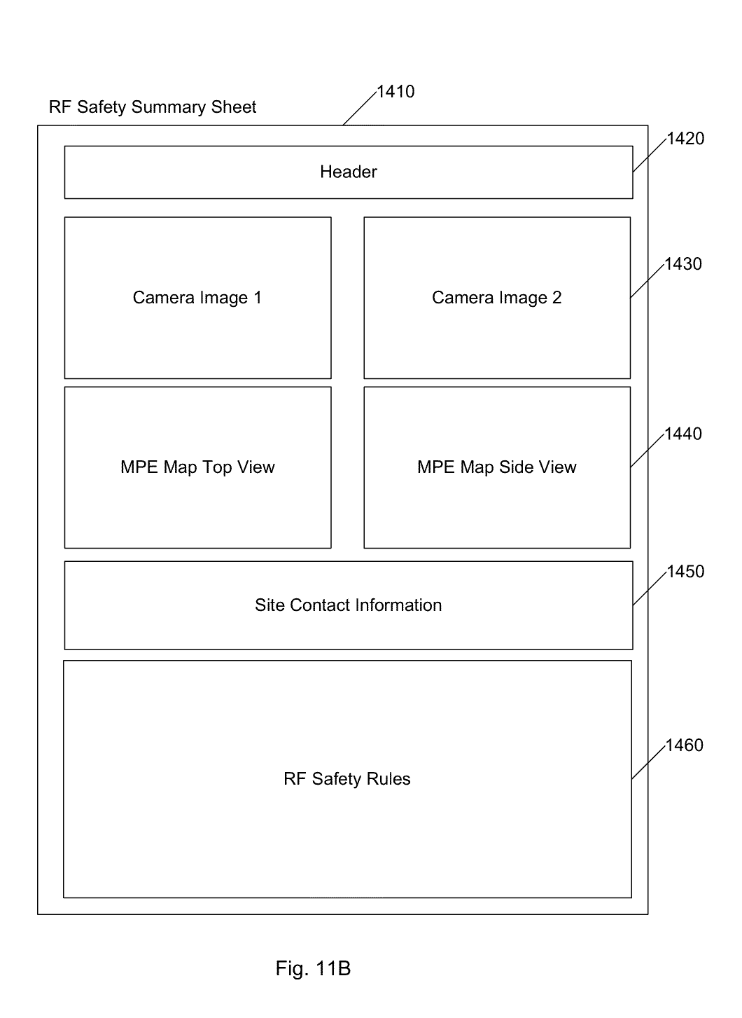

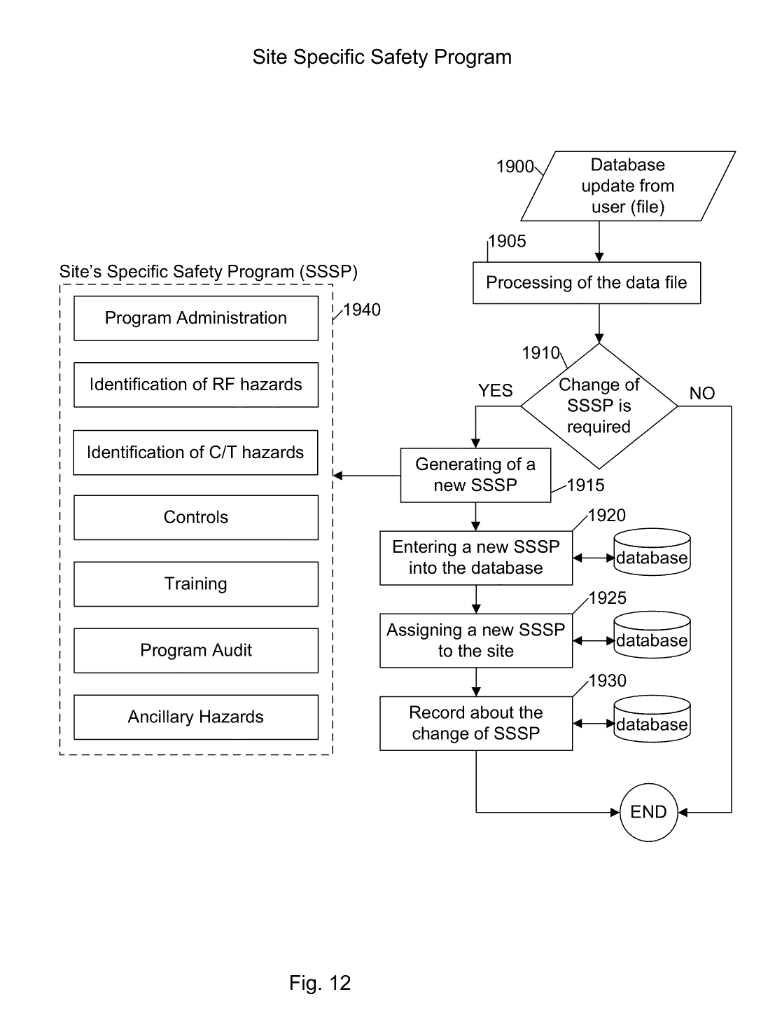

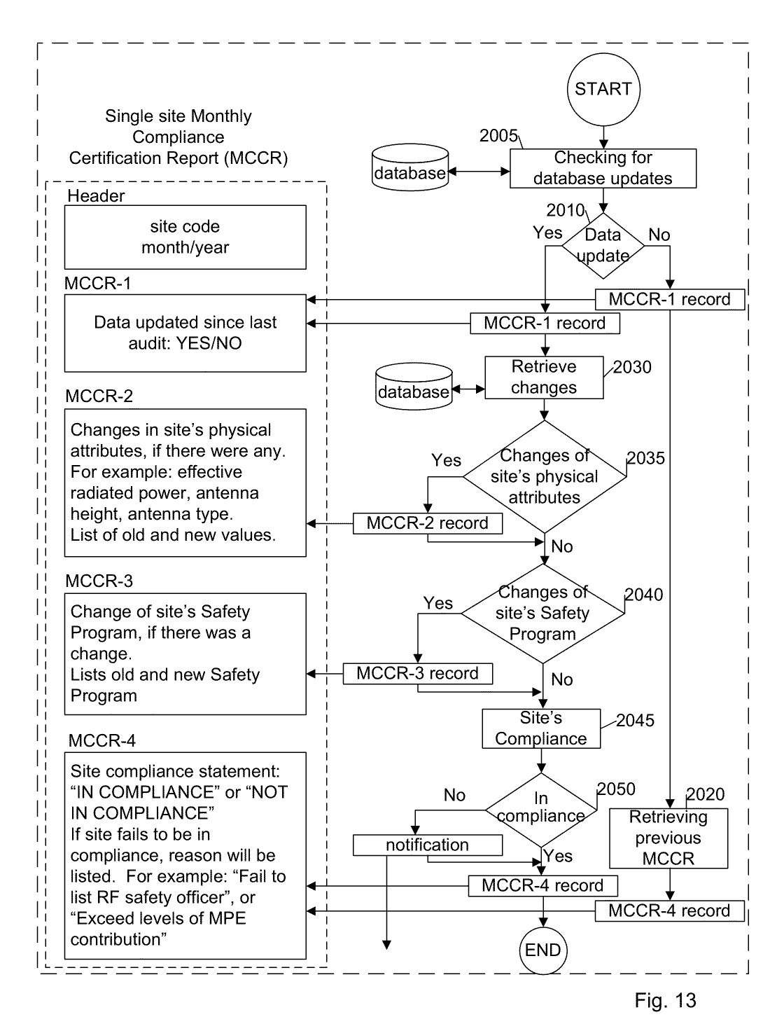

Antenna System table 214 has following key attributes: unique ID; Antenna Structure ID which is associated with the table Antenna Structure 212 and identifies the Antenna Structure which the Antenna System was assigned to; Licensee ID which is associated with the table Contact 226 and identifies the licensee such as Verizon Wireless or AT&T; Spatial Data ID which is associated with the table Spatial Data 230 and identifies spatial data of the antenna system, which will explained in connection with FIGS. 11 and 12; Camera Image ID which is associated with table Camera Image 232 and identifies camera images used by module 435 of FIG. 4; Type identifies the antenna system type such as array of panel antennas.

Antenna Group table 216 is used to join individual antennas into to group for the purpose of assigning RF Information. Antenna Group has following key attributes: unique ID, Antenna System ID which is associated with the Antenna System table 214 and identifies the Antenna System which antenna group was assigned to; Spatial Data ID which is associated with the table Spatial Data 230 and identifies spatial data of the antenna group, which will explained in connection with FIGS. 11 and 12;

Antenna table 218 has following key attributes: unique ID; Antenna Group ID which can be associated with the Antenna Group 216, Antenna Model ID which is associated with the table Antenna Model 220 and identifies antenna model; Spatial Data ID which is associated with the table Spatial Data 230 and identifies spatial data of the antenna.

RF Information table 222 stores the information used to calculate power density levels used for creating MPE maps by module 430 of FIG. 4 and for the Engineering tools functionalities of module 436 of FIG. 4. Table has following key attributes: Input Power, Total Gain, Output Power, Number of Channels, Gain per Channel, Frequency and MPE Map.

Tower Climbing Information table 223 stores the information used to determine the safety level of a site. Factors to determine safety level may include: . . . .

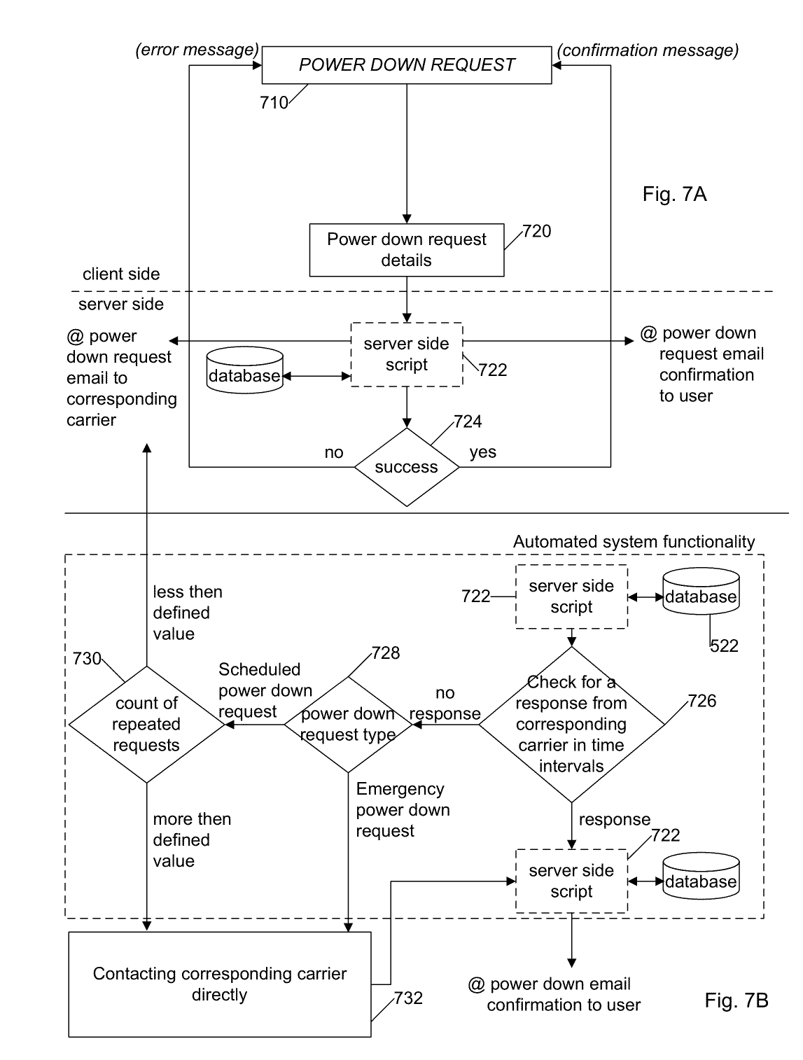

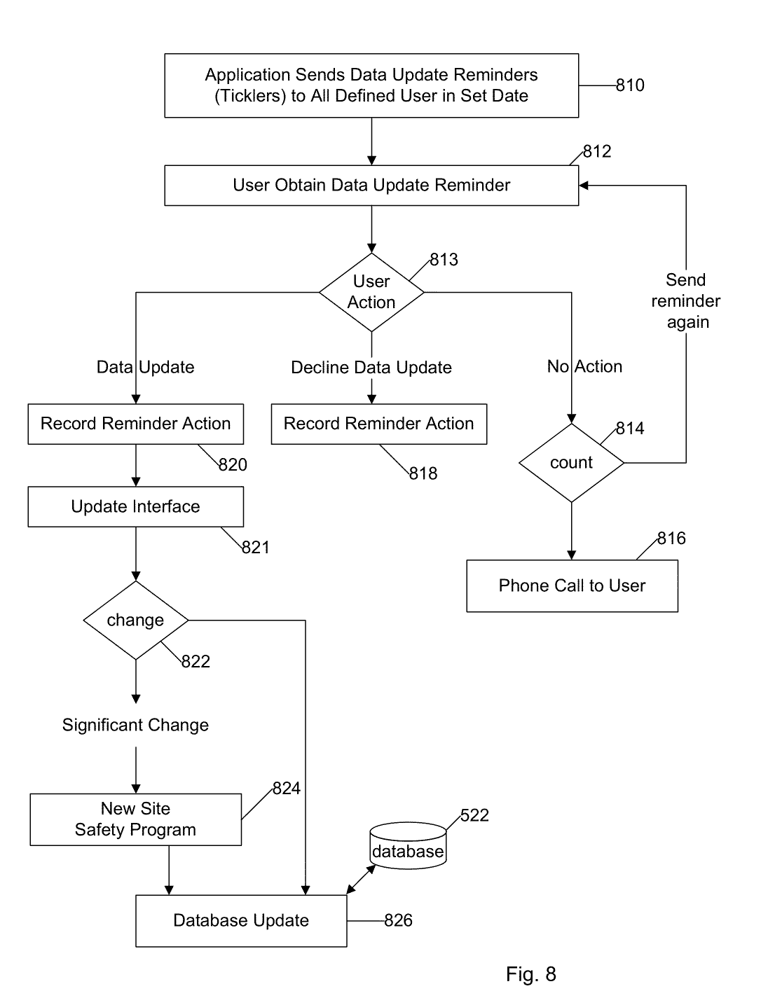

Table Power Down Request 224 is used to store information related to functionality of the module 434 of FIG. 4, which will be explained in connection with FIG. 7. Table has following key attributes: unique ID; Time Stamp which includes exact time and date in which power down was requested; Requestor ID which is associated with the table Contact 226 and identifies the person that requested the power down; Recipient ID which is associated with the table Contact 226 and identifies the recipient of the power down request; Antenna System ID which is associated with the table Antenna System 214 and identifies the antenna system which needs to be powered down; Status which indicates a current status of the power down request such as placed, received, or replied; Content which includes a detail information about the power down request.

Table Site Construction Elements 234 identifies the construction elements of the site such as towers, roofs, stairs, equipment rooms, hatches, or fences. Table has following key attributes: unique ID; label which is displayed on various graphic representations of the site; Site ID which is associated with the table Site 210 and identifies the site which elements was assigned to; Spatial Data ID which is associated with the table Spatial Data 230 and identifies spatial data of the construction element, which will explained in connection with FIGS. 9, 10, 11 and 12;

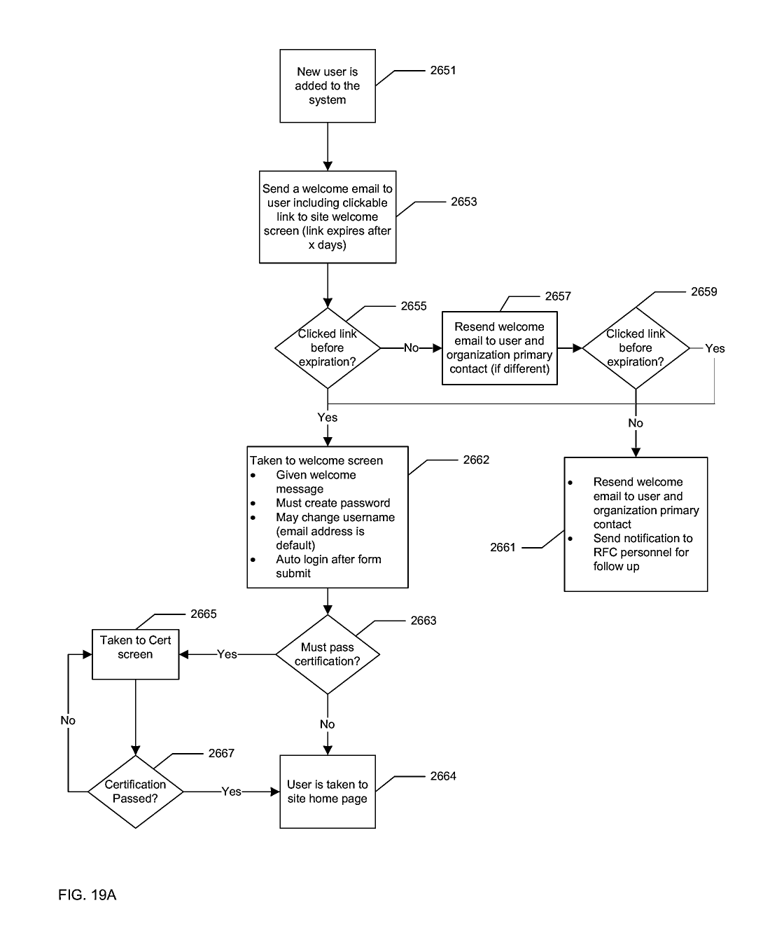

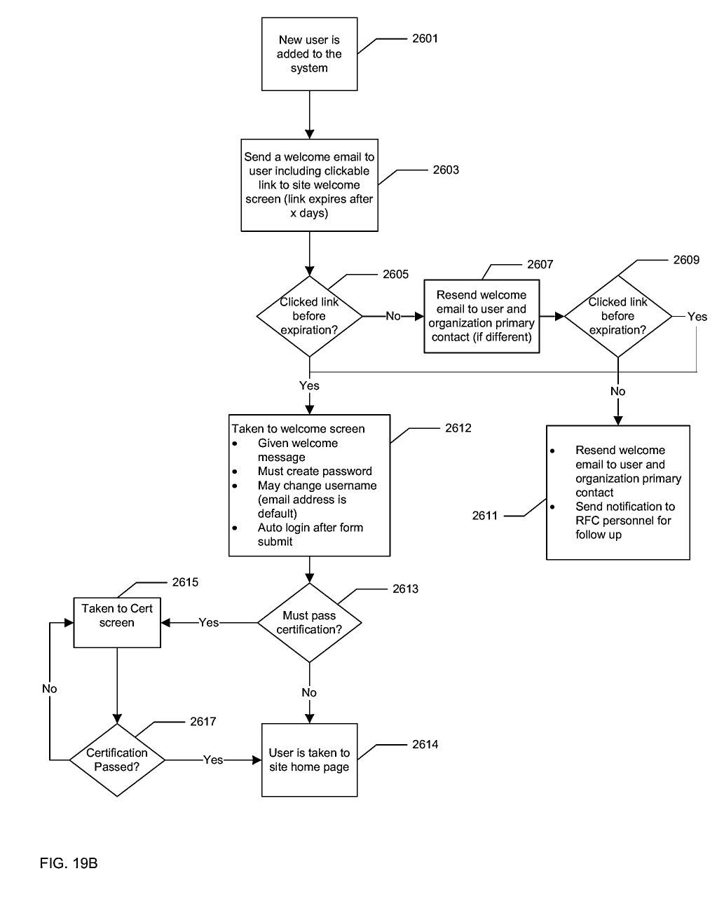

Antenna Safety Program table 236 stores site-specific antenna safety programs associated with the site and is related to module 433 of FIG. 4. Table has following key attributes: unique ID, Site ID which is associated with the table Site 210 and identifies the site which antenna safety program was assigned to; version number which is used to identify various version of the antenna safety program associated with the same site and will be explained in connection with FIG. 19; Time Stamp indicates the data and time when the version of antenna safety program was created.

Table Site Audit 238 stores the information related to site-specific RF compliance audits. Table has following key attributes: unique ID; Site ID which is associated with the table Site 210 and identifies the site which site audit was assigned to; Date which identifies the actual date of the audit; Audit Status identifies a compliance status of the site such as in compliance, or not in compliance; Content includes detailed information related to audit.

Site-specific Climber/Tower Safety Sheet table 241 stores Site-specific Climber/Tower Safety Sheets provided by system to workers, it is related to functionality of the module 439 of FIG. 4 and will be explained in connection with FIG. 14A. Table has following key attributes: unique ID, Tower ID which is associated with the table Tower 210 and identifies the tower which Site-specific Climber/Tower Safety Sheet was assigned to; Content attributes includes a content of the sheet such as accident history, construction elements, minimum climber/tower certification level, camera images, or tower contact information; Version stores the identifier of the version of Site-specific Climber/Tower Safety Sheet for future reference; Time Stamp stores the date and time when Site-specific Climber/Tower Safety Sheet was created.

RF Safety Summary Sheet (site specific) table 240 stores RF safety summary sheets provided by system to workers, it is related to functionality of the module 431 of FIG. 4 and will be explained in connection with FIG. 14B. Table has following key attributes: unique ID, Site ID which is associated with the table Site 210 and identifies the site which RF safety summary sheet was assigned to; Type indicates type of the sheet such as trained worker or general worker; Content attributes includes a content of the sheet such as camera images, MPE maps, or site contact information; Version stores the identifier of the version of RF summary safety sheet for future reference; Time Stamp stores the date and time when RF safety summary sheet was created.

Tower Compliance Report table 242 includes the information related to function of module 446 of FIG. 4 and will be explained in connection to FIGS. 20 and 21. Table has following key attributes: unique ID; Tower ID which is associated with the table Tower 210 and identifies the tower which compliance audit was assigned to; audit Type such as monthly or annual; Content which in details describes compliance status of the tower; Time Stamp stores the date and time when compliance report sheet was created.

Tower Signage table 244 stores the information related to the warning signs associated with the tower and is related to the QR access processing module 423 of FIG. 4. Table 244 can include: unique ID, Tower ID which is associated with the table Tower 210 and identifies the tower which sign was assigned to; Spatial Data ID which is associated with the table Spatial Data 230 and identifies the exact position of the sign relative to a tower; Location Description which is a description of the sign location and mounting, Time Stamp indicates the date and time when the sign was placed on tower; Active indication, which indicates if the sign is currently active/placed on the tower.

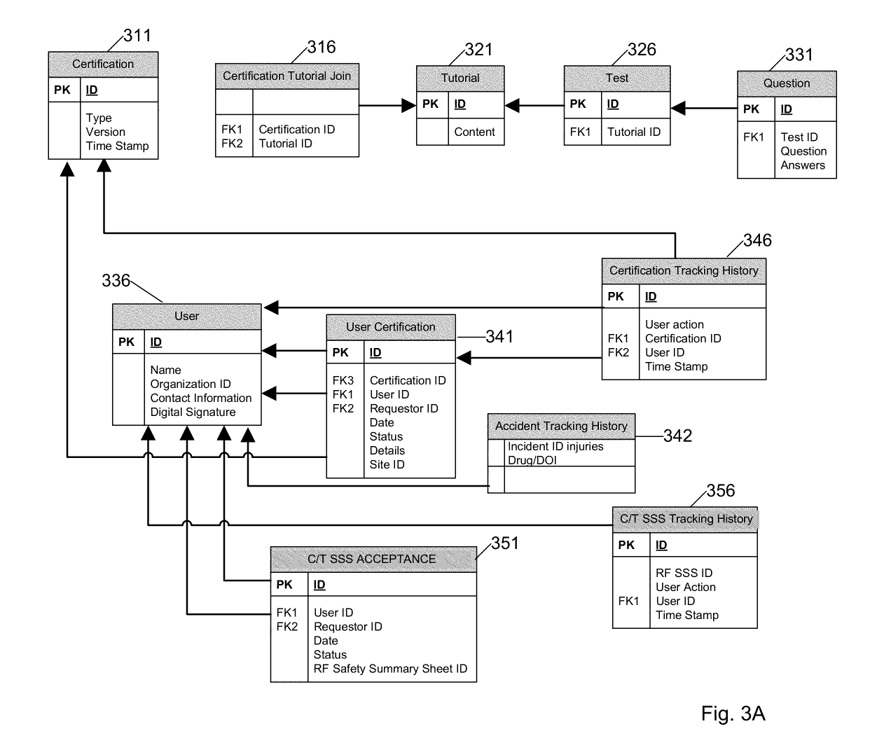

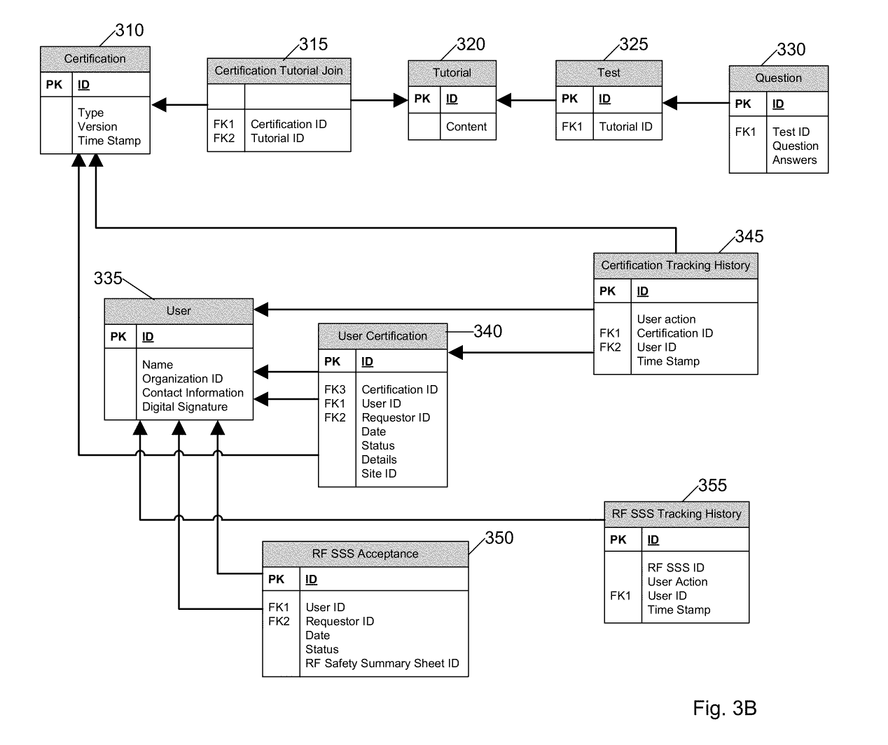

FIG. 3A is a database diagram or schema illustrating the attributes related to Climber/Tower Safety Certification and Site-specific Climber/Tower Safety Sheets. Tables can be implemented on the database server 124 of FIG. 1. The schema includes a tables and data related to functionalities of modules 439 and 427 of FIG. 4. Additionally, the tables can include data described later in connection with FIGS. 22A-26A.

Table Certification 311 includes a various versions of the Climber/Tower Safety Certification and it is used for a new system user who requires Climber/Tower Safety Certification, worker, or contractor company. Table has following key attributes: unique ID; Version which indicates a version of the certification and is used for the future reference; Time stamp is a date and time when the certification was created.

Table Tutorial 321 includes various tutorials that can be assigned to multiple certifications. A table has unique ID and attributes Content which stores actual content of the certification tutorial. Multiple tutorials can be associated with the multiple certification using table Certification Tutorial Join 316. Each tutorial of the certification is followed by an appropriate test which includes various questions. Table Question 331 includes test questions and the possible answers with indication of the correct answer. The table Question is associated with table Test 326 which is associated with the table Tutorial 321.

Table User Certification 341 stores a history of certifications taken by system users. Table has following attributes: unique ID; Certification ID which is associated with the table Certification 311 and identifies the certification; User ID which is associated with the table User 336 and identifies the user who took certification; Requestor ID which is associated with the table Users 336 and identifies the requestor of the certification; Date which indicated the date when certification was taken; Status indicates status of the certification such as completed or uncompleted; Details includes certification test results; Tower ID is associated with the Tower table 210 of FIG. 2.

Table Certification Tracking History 346 is used to provide a detail view of the steps taken by user during the certification, including user's answers to the test questions and tracking of the time user spent on various sections of the certification. The table has following key attributes: unique ID; User action that stores each step user takes during the certification; Certification ID which is associated with the table 311 and identifies certification; User ID which I associated with the table User 336 and identifies the user; Time Stamp that store exact date and time per user action.

Table Accident Tracking History 342 is used to provide accident information of the user. The table has the following key attributes: accidents listed under categorized incident ID's; Injuries suffered by the user or suffered by others; Drug offenses, DUI's (or DWI's), or other pertinent information of the user.

Table Site-specific Climber/Tower Safety Sheet Acceptance 351 is used to track user's acceptance of the Site-specific Climber/Tower Safety Sheets. Table has following key attributes: unique ID; User ID which is associated with the table User 336 and identified the user who accepted Site-specific Climber/Tower Safety Sheet; Requestor ID which is associated with table User 336 and identifies the user who requested acceptance of the Site-specific Climber/Tower Safety Sheet; Date indicates the day when the Site-specific Climber/Tower Safety Sheet was acknowledged, Status indicated the status of the request such as requested or acknowledged; Site-specific Climber/Tower Safety Sheet ID which is associated with the table 241 of FIG. 2 and indicates the Site-specific Climber/Tower Safety Sheet.

Table RF SSS Tracking History 356 is used for tracking the user's actions related to acceptance of RF safety summary sheets. The table has following key attributes: unique ID; User action that stores each step user takes during the acceptance of the RF safety summary sheet; RF SSS ID which is associated with the table 240 of FIG. 2 and identifies RF safety summary sheet; User ID which I associated with the table User 335 and identifies the user; Time Stamp that store exact date and time per user action.

FIG. 3B is a database diagram or schema illustrating the attributes related to RF Certification and (site specific) RF safety summary sheets. Tables can be implemented on the database server 124 of FIG. 1. The schema includes a tables and data related to functionalities of modules 431 and 429 of FIG. 4. Additionally, the tables can include a data described later in connection with FIGS. 22B-26B.

Table Certification 310 includes a various versions of the RF Certification and it is used for a new system user who requires RF certification, worker, or contractor company. Table has following key attributes: unique ID; Type which indicates certification type such as Property Owner Representative RF certification, Trained Worker RF certification; Version which indicates a version of the certification and is used for the future reference; Time stamp is a date and time when the certification was created.

Table Tutorial 320 includes various tutorials that can be assigned to multiple certifications. A table has unique ID and attributes Content which stores actual content of the certification tutorial. Multiple tutorials can be associated with the multiple certification using table Certification Tutorial Join 315. Each tutorial of the certification is followed by an appropriate test which includes various questions. Table Question 330 includes test questions and the possible answers with indication of the correct answer. The table Question is associated with table Test 325 which is associated with the table Tutorial 320.

Table User Certification 340 stores a history of certifications taken by system users. Table has following attributes: unique ID; Certification ID which is associated with the table Certification 310 and identifies the certification; User ID which is associated with the table User 335 and identifies the user who took certification; Requestor ID which is associated with the table Users 335 and identifies the requestor of the certification; Date which indicated the date when certification was taken; Status indicates status of the certification such as completed or uncompleted; Details includes certification test results; Site ID is associated with the Site table 210 of FIG. 2 and indicates the site if the certification was site-specific.

Table Certification Tracking History 345 is used to provide a detail view of the steps taken by user during the certification, including user's answers to the test questions and tracking of the time user spent on various sections of the certification. The table has following key attributes: unique ID; User action that stores each step user takes during the certification; Certification ID which is associated with the table 310 and identifies certification; User ID which I associated with the table User 335 and identifies the user; Time Stamp that store exact date and time per user action.

Table RF SSS Acceptance 350 is used to track user's acceptance of the site-specific RF safety summary sheets. Table has following key attributes: unique ID; User ID which is associated with the table User 335 and identified the user who accepted RF safety summary sheet; Requestor ID which is associated with table User 335 and identifies the user who requested acceptance of the RF safety summary sheet; Date indicates the day when the RF safety summary sheet was acknowledged, Status indicated the status of the request such as requested or acknowledged; RF Safety Summary Sheet ID which is associated with the table 240 of FIG. 2 and indicates the RF safety summary sheet.

Table RF SSS Tracking History 355 is used for tracking the user's actions related to acceptance of RF safety summary sheets. The table has following key attributes: unique ID; User action that stores each step user takes during the acceptance of the RF safety summary sheet; RF SSS ID which is associated with the table 240 of FIG. 2 and identifies RF safety summary sheet; User ID which I associated with the table User 335 and identifies the user; Time Stamp that store exact date and time per user action.

FIG. 4 is a functional block diagram illustrating the functions or modules of one embodiment of the System 100 of FIG. 1. The System includes user modules 420 and system administration modules 450. The user modules 420 provide the operational functionality of the System and the system administration modules provide the administration functionality. The user modules are divided into client side modules and server side modules. The client side modules generally provide the interface functionality for the user interaction. In one embodiment the client side modules run on a remote user computer FIG. 1 110(a-c) and provides a graphic interface to users. The Server side modules run on the server side on the web/application server FIG. 1 120, and interact with database servers 124 and send output to client side.

On the server side the user modules include a user initiation module 422, a database search module 426, a power down request processing module 440, a save/open output of engineering tools module 448, data update processing module 438, RF safety summary sheet processing module 452, RF certification processing module 454, Site-specific Climber/Tower Safety Sheet processing module 453, and Climber/Tower Safety Certification processing module 455. On the user side, the user modules include a tower search module 424, a tower information display module 428, a camera view module 435, an engineering tools module 436, a contacts module 437, a power down request module 434, a data update module 432, a RF summary sheets module 431, a RF certification module 429, a Site-specific Climber/Tower Safety Sheet module 439, and a Climber/Tower Safety Certification module 427.

The user initiation module 422 implements the user logon function (410) including determining whether the user has authorization to use the System and determining what rights the particular user has. This can include providing an initial page (e.g., a web page) that can be accessed as an initial entry point for accessing the system.

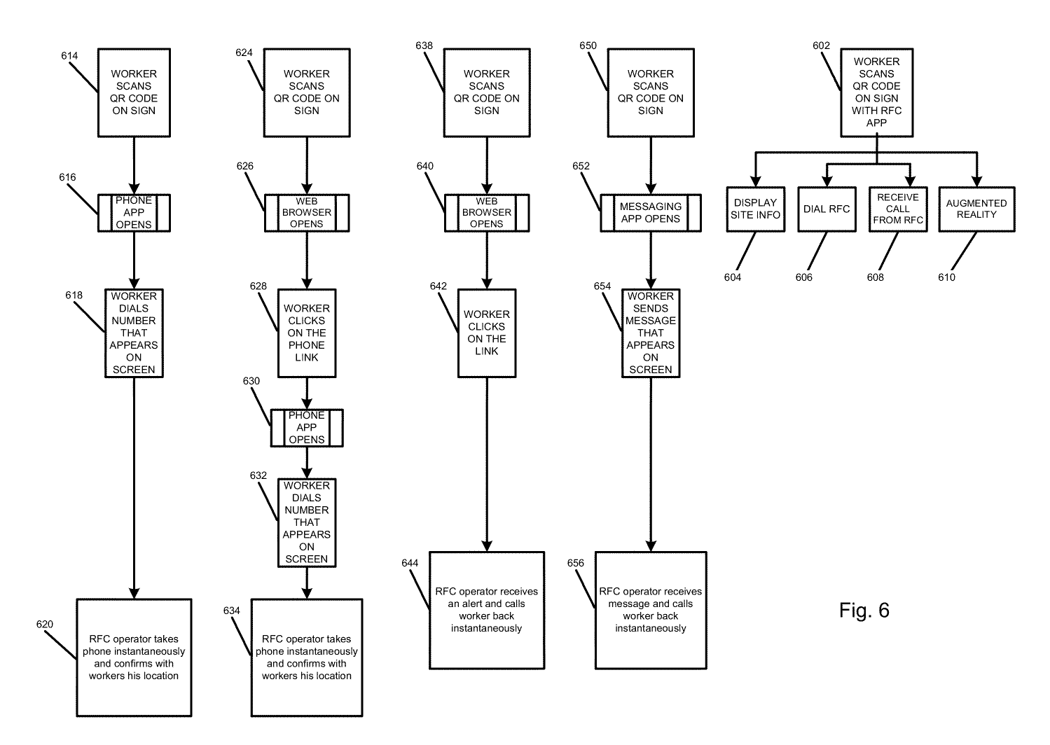

The QR accessing module (or a machine readable indicia accessing module) 423 implements the QR access process which, in one embodiment, is initiated by, for example, a module residing and operating on a user device. This process can provide a simplified access to a tower information which is identified by machine readable indicia which is read by the user device, for example, a cellular telephone. This process is described in more detail in connection with FIG. 6.

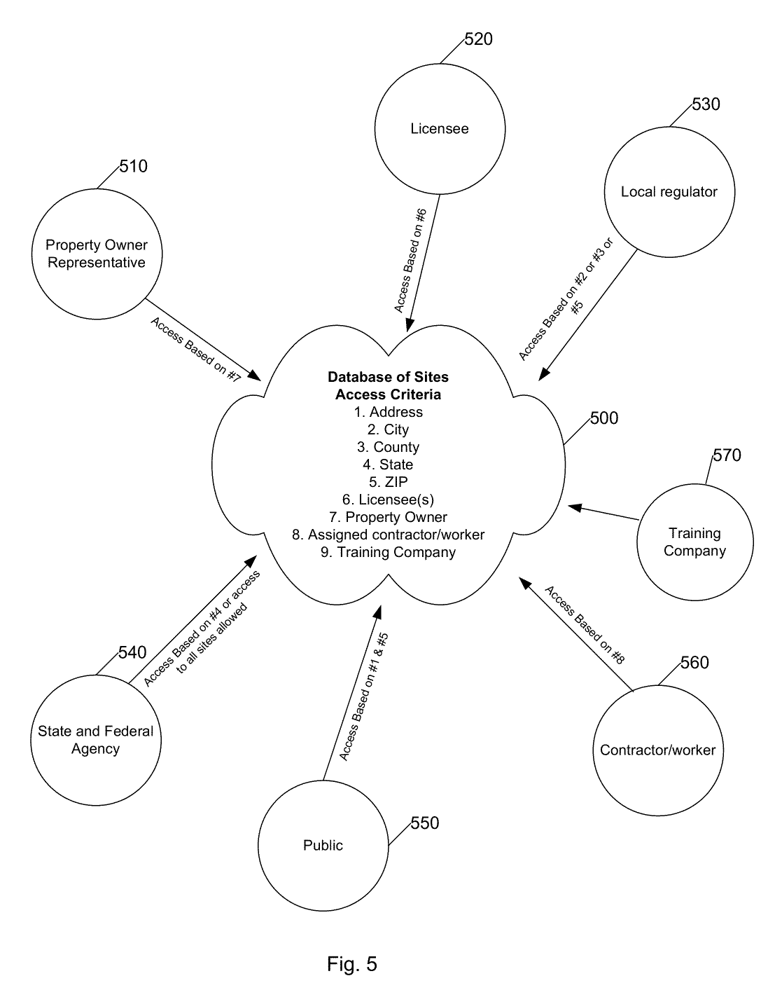

Database Search module 426 searches the database of the towers based on user's role in the system and will be explained in connection with FIG. 5. The database search module 426 resides on web/application servers 120 and interacts with the database servers 124 of FIG. 1. The database search module 426 searches the data base using the various search criteria and provides the results to the tower list module 424. Tower list module 424 provides user with the list of the towers he is authorized to view.

The tower information display module 428 provides the user with information about a specific tower. In one embodiment, the tower information display module shows the user the tower top preview, the geographic map preview, the tower panoramic view or a slideshow of the tower's camera views and tower information. The tower top preview is generated from data in the database. In one embodiment, the tower information display module 428 shows 2-D or 3-D views of a tower. The geographic map preview can be generated using web services or stored images and displays towers on a geographic map. The module allows the user to click on a zoom button or the image itself and a zoomed map view is displayed with a dot that represents the tower location. In one embodiment in order to generate the tower panoramic view or slideshow of the tower's camera views, the camera module 435 loads an external panoramic image of the tower to a system component allowing a simulation of the panoramic view and zoom, or slideshow of the tower's camera views. For the tower information the module displays tower information which includes the items set forth in the tower table of FIG. 2 (210). The module can vary the tower information presented based on the type of user or rights of a user as set forth in the system user database.

From the tower information display module 428 the user can choose to use the functions of the camera view module 435, the data update module 432, the power down request module 434, the engineering tools module 436, the contacts module 437, the RF Safety Summary Sheets module 431, and the Site-specific Climber/Tower Safety Sheet module 439. A user can also enter the RF certification module 429 and the Climber/Tower Safety Certification module 427. However, these modules can also be entered or accessed directly from the user initiation module 422. The site specific program module displays a site specific safety program to a user for RF certification and/or Climber/Tower Safety certification. These modules also update the site specific safety program when changes are made to a site or tower. The functionality of these modules will be explained in connection with FIG. 19.

The camera views module 435 loads and displays multiple types of camera tower views. In one embodiment these views include far and close view. These views are retrieved from the data structure shown in FIG. 2.

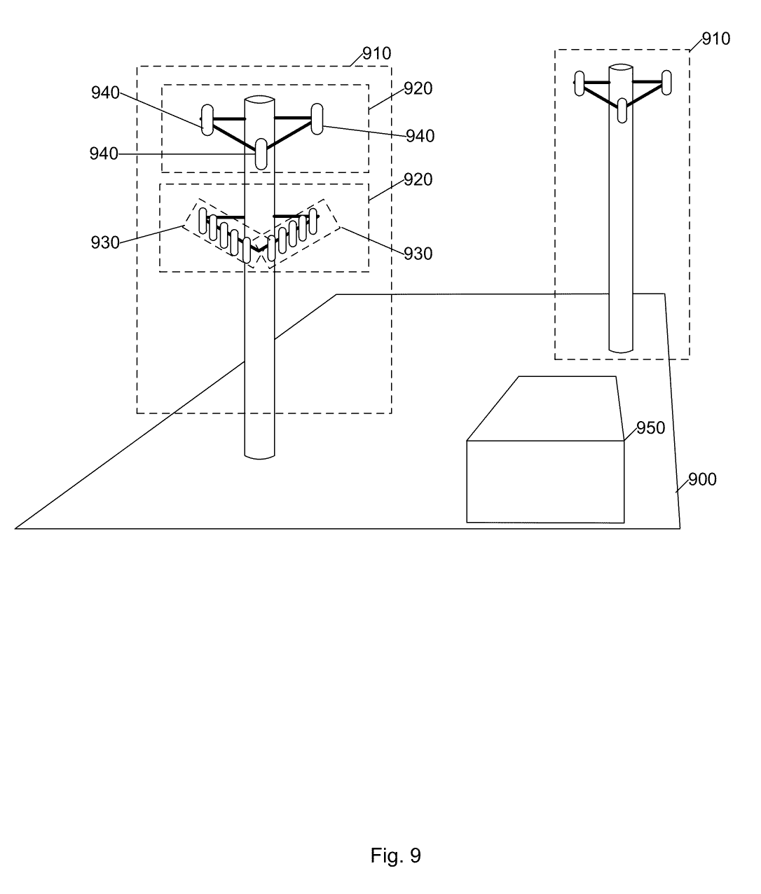

The data update module 432 allows an authorized user (for example a representative of an organization that operates one or more towers) to edit data of the tower that are associated with the authorized user. The data update module also receives data from the tower owner or operator. The module sends the edited data to the data update processing module 438. This data update processing is explained in more detail with FIG. 8 below. The data update processing module provides a site element preview map with selectable antennae structures. In one embodiment a click on an antenna structure displays the following information: antenna label, sector label, antenna structure label, antenna frequency (editable), antenna input power (editable), antenna type (editable), and antenna model (editable). A click on the antennae structure yields an antennae structure zoom view with various antennas each having a link to further screens. A click on a particular antennae yields information including the information set forth in FIG. 2. The data update processing module communicates with the system administration modules 450. The data update module 432 provides the user with the ability to edit editable fields and send updates to the administrator.

The user can also move from the site information display module 428 to the power down request module 434. The power down request module allows the user to request that a particular site's or antenna system at a sites power to be reduced or turned off. The power down request module 434 communicates with the power down request processing module 440. The power down module allows the user to send power down requests for one or multiple antenna system from selected sites. The power down request is sent by email to the broadcaster (operator of the antenna) and a copy of that e-mail to the system administrator. The power down processing module 440 creates a database entry about the power down request and sends confirmation to the user. The scheduled power down request allows the user to send scheduled power down request with information including reason for power down request, selected antenna structures, and date and duration in hours. The power down request has both a manual and automated power down function. A more detailed description of the functioning of the power down request processing module is set forth in connection with FIG. 7 below.

The contacts module 437 displays to the user contact information including tower owner or operator, property owner, wireless service providers and city or municipalities. In one embodiment of a contact contains the following fields: company name, person name, title, phone, fax, cell phone, e-mail, address, city, zip and state.

The Site-specific Climber/Tower Safety Sheet module 439 provides the user the ability to review and print Site-specific Climber/Tower Safety Sheets. The Site-specific Climber/Tower Safety Sheet processing module 453 provides functionally related to sending the request for accepting the Site-specific Climber/Tower Safety Sheet to the user and tracking of the request. All of these processes will be explained in more detail with FIG. 22A.

The RF Safety Summary Sheet module 431 provides the user the ability to review and print Site-specific RF safety summary sheets. The Site Specific Safety Summary Sheet can be provided in two versions. A first version, intended for RF trained workers (explained in more detail below), includes site-specific information for work inside the areas where power density exceeds MPE limits for general, untrained workers. A second version includes site-specific information for work outside the areas where power density exceeded MPE limits and is intended for use by general, untrained workers. If only a black and white printer is available, the module 431 creates a print output suitable for black and white print showing the graphic representation of MPE maps as crosshatched areas. The RF safety summary sheet processing module 452 provides functionally related to sending the request for accepting the RF safety summary sheet to the user and tracking of the request. All of these processes will be explained in more detail with FIG. 22.

The Climber/Tower Safety Certification module 427 and Climber/Tower Safety Certification processing module 455 provide training and certification and tracks the same. The module also provides functionality to ensure that Climber/Tower Safety Certification is completed before providing users with the Site-specific Climber/Tower Safety Sheet. Furthermore the module allows a user to invite others (e.g., contractor companies) to obtain a company Climber/Tower Safety Certification. Once a company becomes certified, they may manage their employees and provide them with a Climber/Tower Safety Certification via the module, and/or to issue the Site-specific Climber/Tower Safety Sheet. Furthermore the system allows workers or contractor companies to complete a Climber/Tower Safety Certification by their own request. The operation and functionality of the Climber/Tower Safety Certification module 427 is described further below in connection with FIGS. 22A-26A.

The RF certification module 429 and RF certification processing modules provide general and site specific training and certification and tracks the same. The module also provides functionality to ensure that RF certification is completed before providing users with the Site Specific RF safety summary sheet. Furthermore the module allows a user to invite others (e.g., contractor companies) to obtain a company RF Certification. Once a company becomes certified, they may manage their employees and provide them with a trained worker RF Certification via the module, and/or to issue the Site-Specific RF safety summary sheet. Furthermore the system allows workers or contractor companies to complete a general RF certification by their own request. The operation and functionality of the RF certification module 429 is described further below in connection with FIGS. 22B-26B.

The system administration modules 450 include a raw tower data processing module 442, a database administration module 444, an automated compliance audit module 446, a data update administration module 447, RF certification & RF safety summary sheet tracking module 449, RF certification tutorials and test management module 450, Climber/Tower Safety Certification & Site-specific Climber/Tower Safety Sheet tracking module 460, and Climber/Tower Safety Certification tutorials and test management module 461. Data update administration module 447 sends reminders through notifying a defined contact to update actual attributes of the tower. Periodic updates are necessary as there are frequent changes to the actual attributes of towers. The automated compliance audit module 446 provides functionality for database audits. It audits the towers which are controlled by the System on a monthly and annual basis to confirm that they are in compliance with International, Federal and State regulations, for example IEEE, FCC, OSHA, ANSI, NATE CTS, SPRAT, IRATA, and NFPA. In one embodiment the data update administration module handles sending requests for data updates to the users (‘out’), and when the user responds (‘in) it evaluates updates.

The database administration module 444 includes the functions to manage the application users, manage power down requests (set forth in FIG. 7A, 7B), manage tower data, and track application usage. In one embodiment the raw tower data processing module 442 performs functions including converting raw data files into the format required by the database structure as seen in FIGS. 2 and 3, and checking the quality of data.

The Climber/Tower Safety Certification & Site-specific Climber/Tower Safety Sheets Tracking module 460 includes functionality that allows system administrator to track all system activities related to Climber/Tower Safety Certification and providing Site-specific Climber/Tower Safety Sheets. System administrator can review all requests for Climber/Tower Safety Certification, all attempts to complete Climber/Tower Safety Certification tutorials and tests including failed, and users' acknowledgements of Climber/Tower Safety Certifications. System administrator can further review in details user's Climber/Tower Safety Certification test results with visibility into every question presented and user's answer. System administrator can further review all requests for providing Site-specific Climber/Tower Safety Sheets to the worker; all accepted requests, including the user's acknowledgement of the Site-specific Climber/Tower Safety Sheets.

The Climber/Tower Safety Certification Tutorial & Test Management module 461 provides the system administrator with ability to create various Climber/Tower Safety Certifications types based on the requirements. The System administrator can create tutorials and tests and assign them to the Climber/Tower Safety Certifications. The module further provides functionality to measure performance of the various Climber/Tower Safety Certifications using the tracking data retrieved from previous user's attempts to complete Certification.

The RF Certification & RF Safety Summary Sheets Tracking module 449 includes functionality that allows system administrator to track all system activities related to RF Certification and providing RF safety summary sheets. System, administrator can review all requests for RF Certification, all attempts to complete RF Certification tutorials and tests including failed, and users' acknowledgements of RF Certifications. System administrator can further review in details user's RF Certification test results with visibility into every question presented and user's answer. System administrator can further review all requests for providing RF safety summary sheets to the worker; all accepted requests, including the user's acknowledgement of the RF safety summary sheets.

The RF Certification Tutorial & Test Management module 450 provides the system administrator with ability to create various RF Certifications types based on the requirements. The System administrator can create tutorials and tests and assign them to the RF Certifications. The module further provides functionality to measure performance of the various RF Certifications using the tracking data retrieved from previous user's attempts to complete RF Certification.

FIG. 5 is a block diagram illustrating the controlled access to towers based on user's role in the system. The described process can be implemented by the corresponding modules 410, 422, 426 depicted in FIG. 4. The database 500 can be implemented as the database servers 124 in FIG. 1 which can include the tower database depicted in FIG. 2. The use of the terms “tower” and “towers” in this description refers to the representations of the towers in the database.

Database 500 includes various attributes that can be used for retrieving search query results based upon the users' roles in the system. A tower owner (or operator) representative (510) can view existing towers owns or operates; search criteria #7 is used—system displays all towers where the current user—Tower Owner Representative—was associated with the tower attribute “tower owner.” A wireless service provider (520) can view existing towers with his antennas on it; search criteria #6 is used—the system displays all towers where the current user—Wireless Service Provider—was associated with the antenna system property “wireless service provider” and those antenna system were associated with the towers.

A local regulator (e.g., a government official) (530) can view existing towers within his jurisdiction; search criteria #2 or #3 is used—the system displays all towers with the matching city, county, or ZIP code. For example city government can view all towers where the database attribute city equals the government's city. Members of the public (550) can view existing and proposed sites within a defined radius from their residence; search criteria #1 and #54 are used. The System converts the user's defined location into GPS location and displays sites within the defined radius from that location. Contractor companies or individual workers (560) can view existing towers that they were assigned to work on. This access type is created using functionality of the RF Safety Summary Sheet module 431, RF Certification module 429, Site-specific Climber/Tower Safety Sheet module 439, and Climber/Tower Safety Certification module 427 of FIG. 4.

Members of State and Federal agencies (540) can view towers based on their jurisdiction on the state level (State Agencies) or have access to all tower within the USA (Federal Agencies); search criteria #4 is used—tower attribute “state”. In the embodiment where access is initiated by the user's access device scanning a machine readable indicia, the user's device would also identify the user to the System automatically (e.g., by provider an identifier of the access device registered to the user or information which identifies the user or both) or the user can log into the system.

The system further allows larger organizations, such as wireless service providers, to manage their access to the database according to their internal organization structure. For example the system allows them to create multiple user accounts for their representatives and assign them access to towers by their region, state or county.

The system further allows training companies 570 to view existing towers in which their current or former trainees are/were employed. The system may also allow training companies 570 to view the specific trainers of such trainees at each tower. In addition, any of the other above groups such as property owner representative 510 or local regulator 530 may also view which training company trained a particular trainee.

In one embodiment the interface with the tower information is presented as a tower top preview map—a tower plot map—with all the tower's elements based on the database data. Tower top preview will be explained in details with connection to FIG. 10 Antenna structure pop-up window shows detailed information about the antenna including MPE horizontal view with buttons allowing the user to switch between antenna arrays, MPE map vertical view with buttons allowing the user to switch between antenna sectors, antenna structure camera views including both standard and close view options, and antenna structure information. In one embodiment antenna structure information can include the antenna structure type, latitude/longitude of the antenna structure, list of antenna arrays with labels and elevations, list of antenna sectors for all antenna arrays with labels and azimuths, and list of all antenna with label, frequency, power, antenna type, and model.

In one embodiment the tower information module 428 also allows the user to filter towers by power line types (high power lines, low power lines, restricted), print information related to RF safety for specific pole numbers, and create an interactive map. The interactive map function allows the user to ‘move’ along the power lines on an interactive map to locate another tower on the same power line. The interactive map displays clickable arrows in the direction of the power line, a click on these arrows moves toward the location. The towers are shown by a dot; a click on a tower dot displays information about the tower.

FIG. 6 is a flow diagram of one embodiment of the process implemented by the QR access module 423 of FIG. 4. This process can provide a simplified access process to information for a tower which is identified by machine readable indicia which is read by a user device, for example, a cellular telephone. The machine readable indicia can be, for example, a matrix barcode (such as a QR code), a two-dimensional barcode, an RFID tag or receiving a wireless transmission, such as a blue tooth transmission. The references to machine readable indicia herein frequently reference a QR code, it should be understood that the invention is not limited that specific type of indicia. The machine readable indicia can be provided on a sign warning of the fall hazard (a warning sign) which can be located at or near to the access points of the tower. Alternative locations, for example on different elevation levels along the tower, can also be used for the machine readable indicia. Scanning or reading the machine readable indicia provides the user device with the information which identifies the tower and the location of the sign at the tower. For example, the machine readable indicia can provide the ID of the tower (see FIG. 2, element 210) and the identification of the specific sign at the tower or another identification of the tower such as its address and the location of the sign. The location of the sign can be important, for example, for towers with multiple antennas.

Referring to FIG. 6, an embodiment of the operation of the QR access processing module 423 will be described. Functions or steps not explicitly described as being performed by a module are performed by the QR processing module 423. At a step 602, a user scans the QR code (or reads another machine readable indicia) using a wireless mobile communication device (e.g., such as a smart phone, a tablet or another device having the capability to scan or read the machine readable indicia) which has specialized software running on the device. The software running on the phone can be configured to immediately obtain and display the tower information for that location from the tower information display module 428 as represented by step 604. For example, the QR processing module can provide the identifier of the tower (from the QR code) to the database search module 426 to obtain the tower information. Alternatively, at a step 606 the software can cause the device to initiate a telephone call with the predetermined telephone number of a call center supported by trained safety specialists. These specialists can then assist the user. The telephone number called can indicate the tower. Alternatively, at a step 608 the user device sends a message including the telephone number of the device (e.g., by a text, email or other communication protocol) in response to which an operator at the phone center calls the user's device. Alternatively, at a step 610 in response to scanning and processing the QR code, the software in the user device can download all the tower information from the system. The user device can then use that information to provide an augment reality for the user. For example, the user device can displaying additional information over top of images captured through the device's camera. In addition, the various operations just described can be presented on the display of the user device as choices which can be selected by the user.

Alternatively, the user device can be a mobile communication device, such as a smart phone, having a standard QR reader. At a step 614, the user scans the QR code using the mobile device in a standard QR reader. At a step 616 the QR reader then causes the phone application on the mobile device to open or launch. At a step 618 the user dials the telephone number that was obtained from the QR code and is displayed in the telephone application. At a step 620 the telephone number connects the user to a call center. The call center personnel can then confirm the caller's location and provide climbing safety assistance. The telephone number of the call center is represented in the QR code.

Alternatively, the QR code can indicate the address of a website. For example, at a step 624, the user scans the QR code using their mobile device including the standard QR reader. At a step 626 the QR reader causes the web browser of the device to launch. At a step 628 the web browser displays tower information specific that tower and includes a link for placing a telephone call for assistance. When the worker clicks on that link, at a step 630 the phone application in the mobile device opens with the telephone number from the website. The worker can then call that number in a step 632. At a step 634, as was explained in connection with step 620, the user is connected to a call center supported by individuals trained for fall protection support.

Alternatively, at a step 638, the user scans the QR code using their mobile device including the standard QR reader. At a step 640 the QR reader causes the web browser of the device to launch the web browser displays tower information specific that tower and includes a link for receiving a telephone call for assistance. At a step 642 the user selects that link. At a step 644 an operator in the call center previously described receives an alert including the telephone number of the mobile device. The operator calls that number and is connected to the user.

Alternatively, at a step 650, the user scans the QR code using their mobile device including the standard QR reader. At a step 652 the QR reader causes a messaging application (e.g., text messaging) of the device to launch. Using data from the QR code, a message is displayed that is prepopulated with the basic identifying information for the tower, the telephone number of the mobile device and a preselected message address. At a step 654 the worker sends the message in order to receive a call back from the call center. At a step 656 an operator in the call center previously described receives an alert including the telephone number of the mobile device. The operator calls that number and is connected to the user.

In each of the above described methods, the time of the contact from the worker, the telephone number of the worker and the location of the tower (and the worker) can be saved, for example as part of the tower compliance report 242.

FIG. 7A is a flow diagram of the power down request functions which can be implemented by modules 434 and 440 of FIG. 4. At step 710 a power down request interface provides the user with the ability to send a power down request for one or multiple antenna structures from a selected site. At step 720 the process provides the user with the ability to enter details relating to the power down request. The user may enter details such as non-compliance with tower climbing safety procedures. This may include non-compliance such as expiration of tower climbing safety certifications or insufficient level of tower climbing safety training. The user may also enter in details such as inclement weather conditions. At Step 722 a power down request email is generated and sent to the broadcaster associated with the antenna, and a confirmation email about sending the power down request is sent to the user, and then a database record about power down request is created. At step 724 if the power down is successful a screen is displayed at 710 stating the emails have been successfully sent.

FIG. 7B is a flow diagram of the functions performed once a power down request email is sent to the wireless telecommunications company. This request is sent automatically by database administration module 444 FIG. 4. At Step 726 at predetermined time intervals a check is carried out to determine if a response from the wireless telecommunication company has been received. If a response is received from the wireless telecommunication company the process proceeds to step 722. At step 722 the response is saved in the database. At step 722 a power down email confirmation is also sent to the user to confirm that the wireless telecommunication company received the power down request. This email may also contain further power down request information. If step 726 determines that no response has been received from the wireless telecommunication company the process proceeds to step 728. Step 728 determines what type of power down request has been sent. In one embodiment the types of power down requests include scheduled and emergency. If the power down request is determined to be an emergency the process proceeds to step 732. At Step 732 the system administrator contacts the wireless telecommunication company directly and notifies them that the antenna structure must be shut down. If the power down request is a scheduled power down the process proceeds to step 730. Step 730 determines the number of repeated power down requests which have been sent to the wireless telecommunication company. If step 730 determines that less than a defined value of repeated power down requests have been sent, step 730 sends another power down request email to the wireless telecommunication company. If step 730 determines that more than a defined value of repeated power down requests have been sent, the system proceeds to step 732. If the system administrator contacted the wireless telecommunication company successfully the system proceeds to step 722, as if the response was received from the wireless telecommunication company.

FIG. 8 is a flow diagram of one embodiment of the process implemented by the data update administration module 447 of FIG. 4. At step 810 data update reminders are sent to all defined users. Defined users and their entered information is obtained from the user database and email reminders are transmitted to each such user. At step 812 the email displays a data update reminder to the user. At step 813 the user can select from action choices including data update or decline data update. If the user chooses the data update function the module routes them to step 820 where the user action, in this embodiment, database update, is “recorded”, in the database. At step 821 the user is provided with an interface for making the update. In one embodiment this interface is made through module 432 of FIG. 4. The quality of the data is checked and the process continues to step 822 where the System verifies any significant change of the data that could affect Site-specific Climber/Tower Safety Program. If there is any significant change, a new Site-specific Climber/Tower Safety Program is created by module 824. At step 826 the module stores the information, in the database. After receiving a response from the server side script, a screen displays information about success of update.

At step 813 if the user declines to update the data, the process proceeds to step 818. At step 818 the user's action, in this case decline the database update is “recorded” in the database. At step 813 if the user takes no action the process proceeds to step 814. At step 814 the process either sends a second reminder or generates a prompt for an administrator to contact the tower owner or wireless service company by telephone or other means. This choice based on the number of times the process has received no action from the user.

FIG. 9 is a graphical representation of a physical site 900 and a generalized site data structure. FIG. 9 is intended to clarify the relationship between the data structure depicted more completely in FIG. 2 and a physical site that can be represented by the data structure. Each site 900 (represented as element 210 in the data structure) may include one or more (generally indicated by the notation “(n)”) antenna structures 910 (represented as element 212 in the data structure). Each antenna structure may include one or more antenna systems 920 (represented as element 214 in the data structure) and each antenna structure may further include one or more groups of antennas 930 (represented as element 216 in the data structure). Each antenna group can include one or more antennas 940 (represented as element 218 in the data structure)

FIG. 10 is a graphical representation of a site plot map based upon data stored in the system which defines the spatial relationships in a horizontal plane between multiple antenna structures at a site and can be provided to users in the site plot map preview. In the example depicted in FIG. 10, three different antenna structures 1030 are located at one site. The Site plot map shows these antenna structures on the area that represents building rooftop 1020. Additionally non-RF elements 1040 are presented such as Air Condition (AC), equipment box, or access point. The system can send this representation to the user's access device where it is displayed.

FIG. 11A is a block diagram representation of the data included in the Site-specific Climber/Tower Safety Sheet presented in the system by module 439 of FIG. 4. Site-specific Climber/Tower Safety Sheet 1411 includes Header 1421 that identifies the tower and the version of Site-specific Climber/Tower Safety Sheet; Camera images 1431; tower contact information 1451 such as tower owner representative or wireless service provider; and Climber/tower Safety Rules 1461 that describes in details rules that worker has to follow. The information allows the system to provide safety information that is specific to each tower.

FIG. 11B is a block diagram representation of the data included in the RF Safety Summary Sheet (RF SSS) presented in the system by module 431 of FIG. 4. RF Safety Summary Sheet 1410 includes Header 1420 that identifies the site and the version of RF SSS; Camera images 1430; MPE maps 1440; site contact information 1450 such as property owner representative or licensee; and RF Safety Rules 1460 that describes in details rules that worker has to follow. The information allows the system to provide safety information that is specific to each site.

FIG. 12 is a flow diagram of one embodiment of an Automated Safety Audit Program of FIG. 4. Site-specific Climber/Tower Safety Program module 433 of FIG. 4 provides user access to a Site-specific Climber/Tower Safety Program 1940 One embodiment of a Site-specific Climber/Tower Safety Program 1940 as depicted in FIG. 19 contains the following categories of information:
“program administration” which includes policies, tower safety officer information, Climber/tower safety officer information, contacts and documentation;
“identification of Climber/tower hazards” which identifies certain hazardous conditions of the tower, such as slippery sides of a tower, tendencies for inclement weather, high winds, or poor visibility;
“controls” which includes energy controls, signs to look for, safe work practices, Climber/tower monitoring, and personnel protective practices; “training” which includes training programs for climber/tower safety such as Authorized Climber, Competent Climber, Rescue Climber, Train the Trainer, and others; general public workers in areas where RF energy is too low to cause exposure above public limits, for workers in areas where energy may cause exposure above public limits, and for workers in areas where RF may cause exposure in excess of occupational limits unless workers utilize special controls and records of who has received the training;
“program audit” which contains information regarding responsibilities and audit reports; and
“ancillary hazards” can include, for example, the identity and locations of hazardous materials at the tower and lockout agents. The automated safety audit program updates a Site-specific Climber/Tower Safety Program when relevant changes are made at the tower.

Referring to FIG. 12 automated safety audit program processes the database update file from the user at step 1900. In one embodiment, the update data file includes an array of keys and values, where ‘key’ is the identification of the columns in the database and ‘value’ is an updated value. If the file does not include a key for the particular database column, the process considers that the value was not changed and the current value is used if the Site-specific Climber/Tower Safety Program (or the Site-specific Climber/Tower Safety Sheet) needs to be changed. If new data is entered, the process proceeds to step 1905. At step 1905 the data entered by the user is processed by the System. The process determines if the updated values effect the existing Site-specific Climber/Tower Safety Program, or if data directly include values that need to be changed in the Site-specific Climber/Tower Safety Program. The following are examples of this process.
Example 1: If there is a modification to the tower structure of a tower, such that it causes greater difficulty in climbing the tower, then the Site-specific Climber/Tower Safety Program may be modified to reflect a higher level of climber/tower certification required to perform work on the modified tower structure.
Example 2: If the input power of the transmitter is changed, this will change the location of the MPE boundaries. The MPE limits would then need to be recalculated and the existing SSSP would need to be changed. A new or modified SSSP would then be generated to replace the existing one.
Example 3: If the data update file includes a new tower's safety officer, the information for the safety officer would need to be changed and a new Site-specific Climber/Tower Safety Program would then be generated to replace the existing one.
Example 4: If the broadcasting frequency was changed, but it doesn't affect any part of the existing SSSP, then a new SSSP will not be generated.

At step 1910 if no change to the Site-specific Climber/Tower Safety Program is required the process ends. However, if a change to the Site-specific Climber/Tower Safety Program is required the process proceeds to step 1915 where a new or modified Site-specific Climber/Tower Safety Program is generated. Once a new Site-specific Climber/Tower Safety Program is generated, the system proceeds to step 1920 where the new Site-specific Climber/Tower Safety Program is entered into the database. At step 1925 the new Site-specific Climber/Tower Safety Program is given a unique id and assigned to the tower. At step 1930 the process records the Site-specific Climber/Tower Safety Program ID change in the database. This record includes data on the old Site-specific Climber/Tower Safety Program ID, the new Site-specific Climber/Tower Safety Program ID, and the tower identification code as seen in table 210 and 214 of FIG. 2A.

Though the foregoing description focused on the Site specific Safety Program, it should be noted that the process also applies to the Site specific RF Safety Summary Sheet and the Site specific Climber/Tower Safety Sheet. Additionally, if the RF Safety Summary Sheet or the Site specific Climber/Tower Safety Sheet is updated during the process, previously issued site specific certifications are indicated as invalid in the database. Additionally, such an update to the RF Safety Summary Sheet or the Site specific Climber/Tower Safety Sheet can trigger the process described below in connection with FIG. 24A or FIG. 24B where the system prompts a user to obtain a certification (in this case a re-certification). Notices can also be sent by the system to registered users that have received the site specific RF Safety Summary Sheet or the Site specific Climber/Tower Safety Sheet informing them that the old sheet is no longer valid.

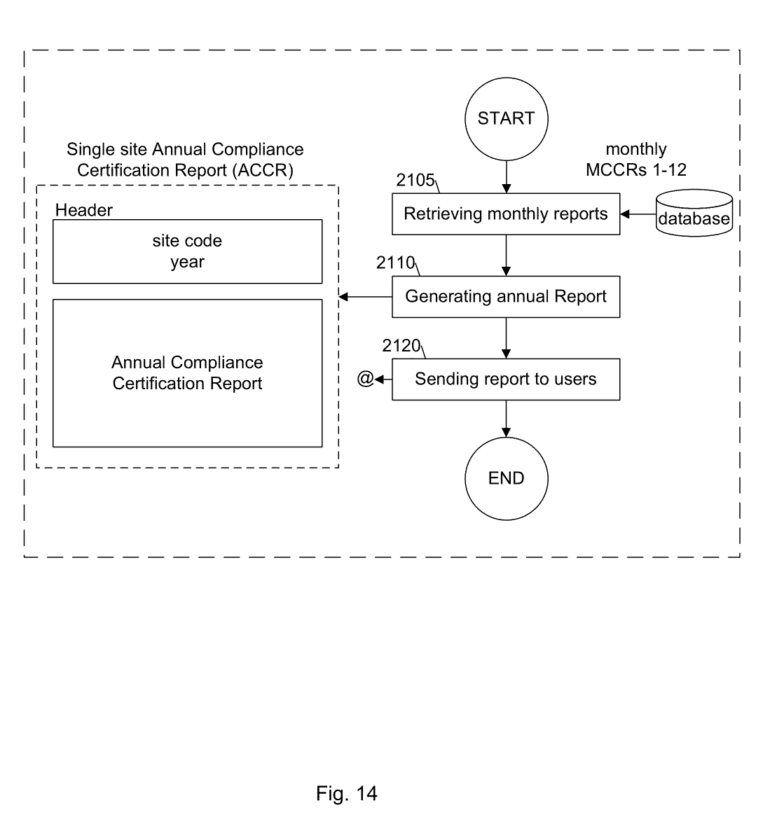

FIGS. 13 and 14 are flow diagrams of one embodiment of an automated compliance audit program (ACAP) implemented by the automated compliance audit module 446 of FIG. 4. The System executes a periodic, for example, monthly, ACAP for every tower and creates and stores a monthly compliance certificate report (MCCR) as shown in FIG. 13. In one embodiment the MCCR includes the tower code and the date (header), indicates whether the data has been updated since the last audit (MCCR-1), indicates what changes were made to the tower since the last audit (MCCR-2), lists both the old and new Site-specific Climber/Tower Safety Program if a new program was created (MCCR-3) and states whether the tower is in compliance (MCCR-4). If the tower is not in compliance the System sends a notification to the appropriate party. The System can also execute an annual compliance certificate report (“ACCR”) for all users and the towers they manage. The ACCR reports can be automatically generated and sent to the users as seen in FIG. 14. The MCCRs and the ACCRs are generated as computer records and/or printed. The computer records are time stamped and encrypted so that they cannot be altered. These reports are designed to meet the requirements of all applicable regulations, such as international, Federal and State regulations.

Referring to FIG. 13 at step 2005 the process checks the database for any new data updates since the last audit. At step 2010 if no data updates are found, the System generates an MCCR-1 record indicating that no changes have occurred. The process proceeds to step 2020 where the previous MCCR is retrieved. The MCCR is updated monthly and used in the final tower compliance statement MCCR-4. The process determines whether the tower is in compliance with the current regulations applicable to that tower. The System includes all applicable regulations or consensus based industry standards. The System can also determine which regulations apply to the tower. Whether the tower is in compliance is then added to the MCCR. If the tower is not in compliance, the reason for the non-compliance is added to the MCCR and notification is sent to the appropriate party. For example, the reason could be “overworked field workers” or “less than 100% tie off”. The reason could also include “failure to list tower safety representative”. Finally, the MCCR record is time stamped and encrypted so that it cannot be altered.

At step 2010 if updated data is found, the process proceeds to step 2030. At step 2030 the process retrieves data changes from the database. At step 2035 the process determines if the data changes relate to the tower's physical attributes, for example dangerous tower conditions, tower structure, antennas placement. If the changes relate to the towers physical attributes, the process generates a list of old and new values which are stored in the MCCR and the process proceeds to step 2040. If the changes don't relate to the towers physical attributes the process proceeds to step 2040. At step 2040 the process verifies any change in the Site-specific Safety Program (or the Site-specific Climber/Tower Safety Program or the RF Safety Program) since the last MCCR. If a change occurred the System creates an MCCR record that lists the old and new Site-specific Climber/Tower Safety Program and the process proceeds to step 2045. At step 2045 the System analyzes updated data and determines if the tower is in compliance with the applicable regulations. At step 2050, if the tower is in compliance, the System creates tower compliance statement MCCR-4 which states “IN COMPLIANCE” and ends the process. If the tower is not in compliance, the System sends notification to appropriate party, creates a tower compliance statement MCCR-4 which states “NOT IN COMPLIANCE”, describes the reasons for the non-compliance and ends the process.

Referring to FIG. 14 at step 2105 the process retrieves the MCCR's from the database for the tower being audited. At step 2110 an ACCR is generated by compiling all of the data from the MCCR's. The ACCR contains a tower code year and an annual compliance certificate report. At step 2120 the ACCR is time stamped, encrypted and stored in the database. Additionally, a copy of the ACCR can be sent to the user associated with the tower.

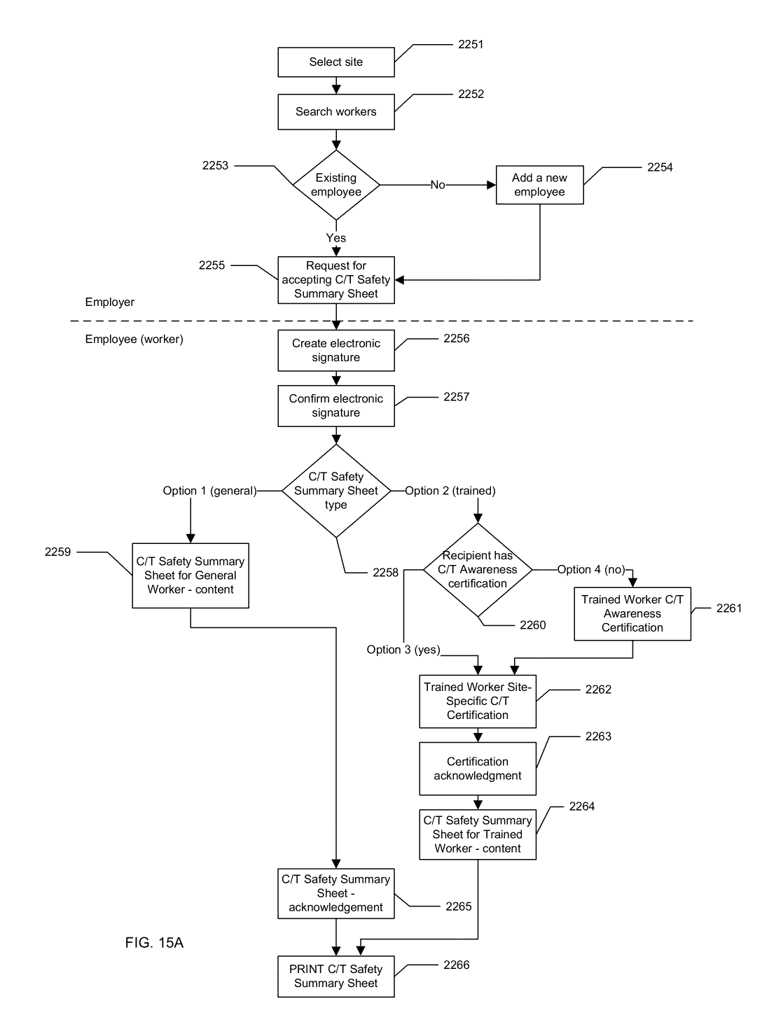

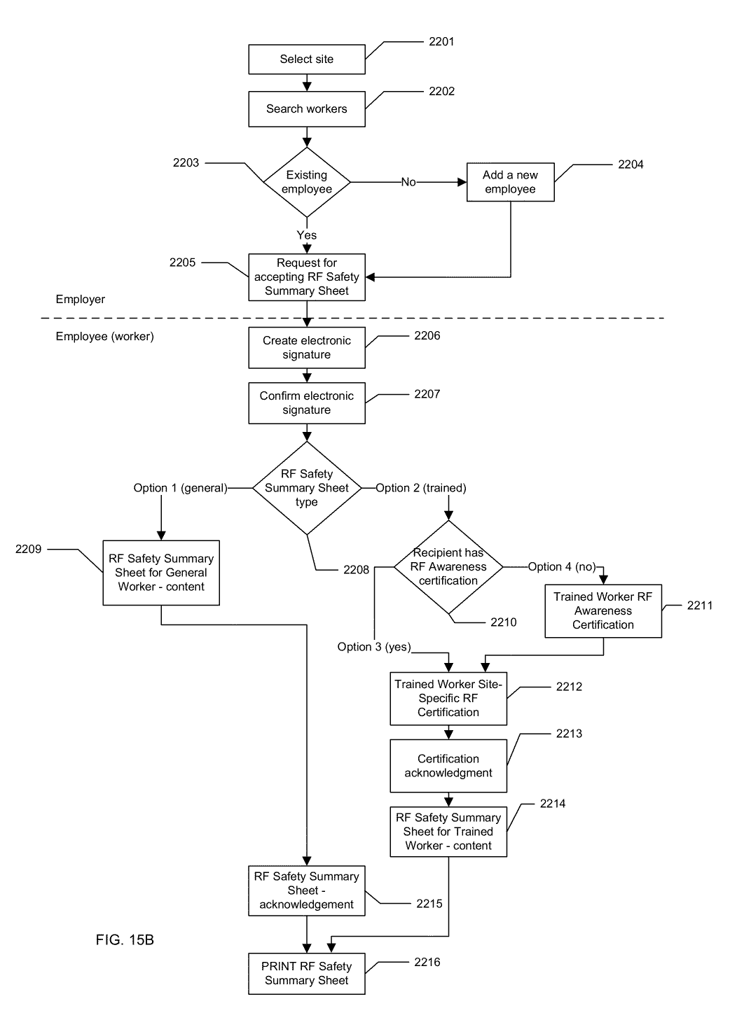

FIG. 15A is a flow diagram of functionality provided by the Climber/Tower Safety Certification module 427 of FIG. 4. A user can access the module via the tower information display as was mentioned above. The module allows a user to search for any worker listed in the database or only those workers that have received Climber/Tower Safety Certification step 2252. In one embodiment, the user's search is limited to employees of the user's company or organization. If the search does not present the desired employee (step 2253), the system allows the user to add a new employee to the database at step 2254. The system also provides the ability to issue the appropriate Site-specific Climber/Tower Safety Sheet to either type of worker (new or existing) beginning with the request sent by employer to his employee at step 2255.

In one embodiment, the module presents all CT trained workers (employees) for the selected tower at step 2252. To be qualified, the employee can have a current Worker CT Certification (e.g., certification date is equal to or less than one year old). Additionally, if the User requests general workers, the system will present all employees that do not have a current Worker CT Certification but have acknowledged the Site-specific Climber/Tower Safety Sheet (acknowledgement date is equal to or less than one year old). If the database indicates that the candidate (worker) has acknowledged the receipt of the current Site-specific Climber/Tower Safety Sheet for CT Certified Worker, the acknowledgement date will be presented. The system determines whether the acknowledged Site-specific Climber/Tower Safety Sheet is identical to the current version. If the user wishes to view additional details of any selected worker, they can select the view details option. The system allows the User to request that his worker become part of the system database. This request is based upon the need to provide a CT Certified or General Worker with the appropriate Site-specific Climber/Tower Safety Sheet or to provide a user's worker with a Worker CT Certification. If the User is adding a new worker (step 2254), the user must select the month and day of the birth date of the desired worker, the last 4 digits of the desired worker's Social Security Number (SSN) (or other identifier), and worker's first and last name. When the User has entered the above fields, they can select the Lookup function and the system will determine whether the worker was previously entered into the system. The system will perform an exact match on date of birth and the last 4 digits of the worker's SSN. If the worker is found in the database, an informational message will be presented and the contact information fields will be filled with the information contained in the database. If the worker is not duplicated, the user must provide the additional information about the worker such as title, address, email address, phone number.

At step 2255, the user can select a “Provide Site-specific Climber/Tower Safety Sheet by Email” option. Then, the system will validate that the selected worker has an associated email. If the email exists, the system annotates the date and time that the request was sent. The system also creates a secure link and sends an email to the selected worker. If the user selects the Provide on-site option, the system will annotate the date and time that the worker was presented the electronic signature screen. If the user stops the process before selecting the Provide Site-specific Climber/Tower Safety Sheet option, the system will logoff the user to restrict the worker's system access privileges.

A worker electronic signature page is implemented by the module as represented by steps 2256 and 2257 and provides reasonable evidence that the intended worker is the individual that will participate in the Climber/Tower Safety Certification. At step 2256 the worker enters their date of birth month and day, last 4 digits of their Social Security Number, and their first and last name. The system performs an exact match on date of birth, the last 4 digits of the worker's SSN and the worker's last name. Upon all fields successfully matching, the worker will be presented with the Electronic Signature Confirmation page at a computer station being used by the worker at step 2257. The purpose of the Worker Electronic Signature Confirmation page is to affirm and record that the worker accepts the presented signature as an authorized and binding signature. The Worker Electronic Signature Confirmation screen presents the worker's personal and contact information as read-only information. It will also “stylize” the first and last name of the individual. Lastly, it will stylize the first and last name initial as the individual's electronic Initials. The individual may select the “I accept my electronic signature” or Cancel option. If the individual selects the “I accept my electronic signature” option, the system will determine the appropriate Site-specific Climber/Tower Safety Sheet to present to the individual (Step 2258).

If the individual was requested for Climber/Tower Safety Certification, the system will present the current version of the certification. The system will create a secure (unique) document id that is comprised of the following: First Name, Last Name, Birth Date, Last 4 digits of the worker's SSN (or other identifier), System date and time, and Document ID. The Document ID is the Document Name and Version number. For example WGRFAC-V1.7 would indicate Trained Worker TC Certification, version 1.7.

Based on the request type from the worker's employer, the system will choose next steps in the process as represented by step 2258. Option 1 is for a General Worker—Site-specific Climber/Tower Safety Sheet for General Worker. If the individual was requested for a Site-specific Climber/Tower Safety Sheet for General Worker, the system will present the Site-specific Climber/Tower Safety Sheet for General Worker as indicated at step 2259. The General Worker then must acknowledge to the system the Site-specific Climber/Tower Safety Sheet for General Worker at step 2265. In step 2266, the General Worker can print the Site-specific Climber/Tower Safety Sheet for General Worker.

Option 2 is for a Trained Worker—Site-specific Climber/Tower Safety Sheet for trained Worker. In order to receive the Site-specific Climber/Tower Safety Sheet for a trained Worker, the worker must complete the Trained Worker CT Certification and Trained Worker Site-Specific CT Certification provided by the system. The system will determine first whether the individual has a valid Trained Worker CT Certification (Step 2260). If the worker has a valid Trained Worker CT Certification (Option 3 in Step 2260), the system proceeds to step 2262. If not (Option 4 in Step 2260), the system causes the worker to first complete the Trained Worker CT Certification (Step 2261) and the system then continues to step 2262.

After completion of the Worker Site-Specific Certification (Step 2262), the worker must acknowledge his certifications (Step 2263) and this is indicated in the database. Once acknowledged, the worker can proceed to step 2264. At step 2264, the system presents the Site-specific Climber/Tower Safety Sheet. The Worker then must acknowledge the Site-specific Climber/Tower Safety Sheet (Step 2265) and the acknowledgement is indicated in the database. In step 2266, the Worker can print the Site-specific Climber/Tower Safety Sheet. The acknowledgement screens present the individual's name, current date & time, the specific tower address and the system generated Secure Document ID created at the beginning of the process. The individual's previously accepted signature will be created and presented when the Sign option is selected.

FIG. 15B is a flow diagram of functionality provided by the RF certification module 429 of FIG. 4. A user can access the module via the site information display as was mentioned above. The module allows a user to search for any worker listed in the database or only those workers that have received RF Certification step 2202. In one embodiment, the user's search is limited to employees of the user's company or organization. If the search does not present the desired employee (step 2203), the system allows the user to add a new employee to the database at step 2204. The system also provides the ability to issue the appropriate Site Specific RF safety summary sheet to either type of worker (new or existing) beginning with the request sent by employer to his employee at step 2205.

In one embodiment, the module presents all RF trained workers (employees) for the selected site at step 2202. To be qualified, the employee must have a current Worker RF Awareness Certification (e.g., certification date is equal to or less than one year old). Additionally, if the User requests general workers, the system will present all employees that do not have a current Worker RF Awareness Certification but have acknowledged the Site Specific RF safety summary sheet (acknowledgement date is equal to or less than one year old). If the database indicates that the candidate (worker) has acknowledged the receipt of the current Site Specific RF safety summary sheet for Certified Worker, the acknowledgement date will be presented. The system determines whether the acknowledged Site Specific RF safety summary sheet is identical to the current version. If the user wishes to view additional details of any selected worker, they can select the view details option. The system allows the User to request that his worker become part of the system database. This request is based upon the need to provide a RF Certified or General Worker with the appropriate Site Specific RF safety summary sheet or to provide a user's worker with a Worker RF Awareness Certification. If the User is adding a new worker (step 2204), the user must select the, month and day of the birth date of the desired worker, the last 4 digits of the desired worker's Social Security Number (SSN) (or other identifier), and worker's first and last name. When the User has entered the above fields, they can select the Lookup function and the system will determine whether the worker was previously entered into the system. The system will perform an exact match on date of birth and the last 4 digits of the worker's SSN. If the worker is found in the database, an informational message will be presented and the contact information fields will be filled with the information contained in the database. If the worker is not duplicated, the user must provide the additional information about the worker such as title, address, email address, phone number.

At step 2205, the user can select a “Provide Site Specific RF safety summary sheet by Email” option. Then, the system will validate that the selected worker has an associated email. If the email exists, the system annotates the date and time that the request was sent. The system also creates a secure link and sends an email to the selected worker. If the user selects the Provide on-site option, the system will annotate the date and time that the worker was presented the electronic signature screen. If the user stops the process before selecting the Provide Site Specific RF safety summary sheet option, the system will logoff the user to restrict the worker's system access privileges.

A worker electronic signature page is implemented by the module as represented by steps 2206 and 2207 and provides reasonable evidence that the intended worker is the individual that will participate in the Trained Worker RF Certification and/or Trained Worker Site Specific RF Certification. At step 2206 the worker enters their date of birth month and day, last 4 digits of their Social Security Number, and their first and last name. The system performs an exact match on date of birth, the last 4 digits of the worker's SSN and the worker's last name. Upon all fields successfully matching, the worker will be presented with the Electronic Signature Confirmation page at a computer station being used by the worker at step 2207. The purpose of the Worker Electronic Signature Confirmation page is to affirm and record that the worker accepts the presented signature as an authorized and binding signature. The Worker Electronic Signature Confirmation screen presents the worker's personal and contact information as read-only information. It will also “stylize” the first and last name of the individual. Lastly, it will stylize the first and last name initial as the individual's electronic Initials. The individual may select the “I accept my electronic signature” or Cancel option. If the individual selects the “I accept my electronic signature” option, the system will determine the appropriate Site Specific RF safety summary sheet to present to the individual (Step 2208).

If the individual was requested for Trained Worker RF Certification only, the system will present the current version of the certification. The system will create a secure (unique) document id that is comprised of the following: First Name, Last Name, Birth Date, Last 4 digits of the worker's SSN (or other identifier), System date and time, and Document ID. The Document ID is the Document Name and Version number. For example WGRFAC-V1.7 would indicate Trained Worker RF Certification, version 1.7.

Based on the request type from the worker's employer, the system will choose next steps in the process as represented by step 2208. Option 1 is for a General Worker—Site Specific RF Safety Summary Sheet for General Worker. If the individual was requested for a Site Specific RF Safety Summary Sheet for General Worker, the system will present the Site Specific RF Safety Summary Sheet for General Worker as indicated at step 2209. The General Worker then must acknowledge to the system the RF Safety Summary Sheet for General Worker at step 2215. In step 2216, the General Worker can print the Site Specific RF Safety Summary Sheet for General Worker.

Option 2 is for a Trained Worker—Site Specific RF Safety Summary Sheet for trained Worker. In order to receive the Site Specific RF Safety Summary Sheet for a trained Worker, the worker must complete the Trained Worker RF Certification and Trained Worker Site-Specific RF Certification provided by the system. The system will determine first whether the individual has a valid Trained Worker RF Certification (Step 2210). If the worker has a valid Trained Worker RF Certification (Option 3 in Step 2210), the system proceeds to step 2212. If not (Option 4 in Step 2210), the system causes the worker to first complete the Trained Worker RF Certification (Step 2211) and the system then continues to step 2212.

After completion of the Trained Worker Site-Specific Certification (Step 2212), the worker must acknowledge his certifications (Step 2213) and this is indicated in the database. Once acknowledged, the worker can proceed to step 2214. At step 2214, the system presents the Site Specific RF Safety Summary Sheet for Trained Worker. The Trained Worker then must acknowledge the RF Safety Summary Sheet for Trained Worker (Step 2215) and the acknowledgement is indicated in the database. In step 2216, the Trained Worker can print the Site Specific RF Safety Summary Sheet for Trained Worker. The acknowledgement screens present the individual's name, current date & time, the specific site address and the system generated Secure Document ID created at the beginning of the process. The individual's previously accepted signature will be created and presented when the Sign option is selected.

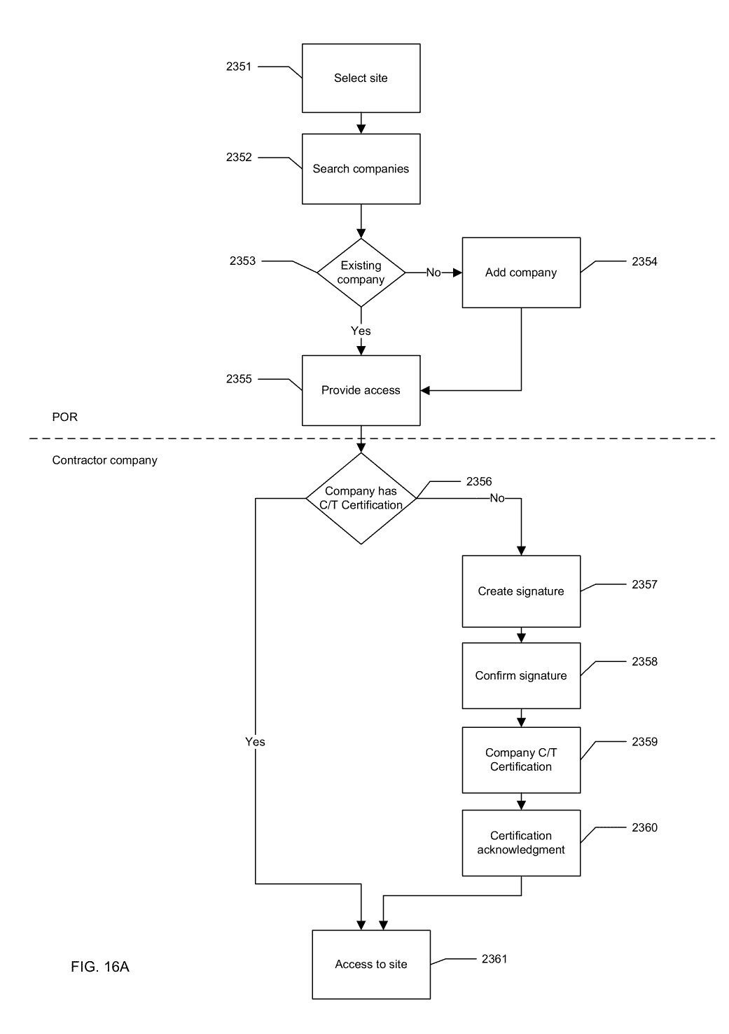

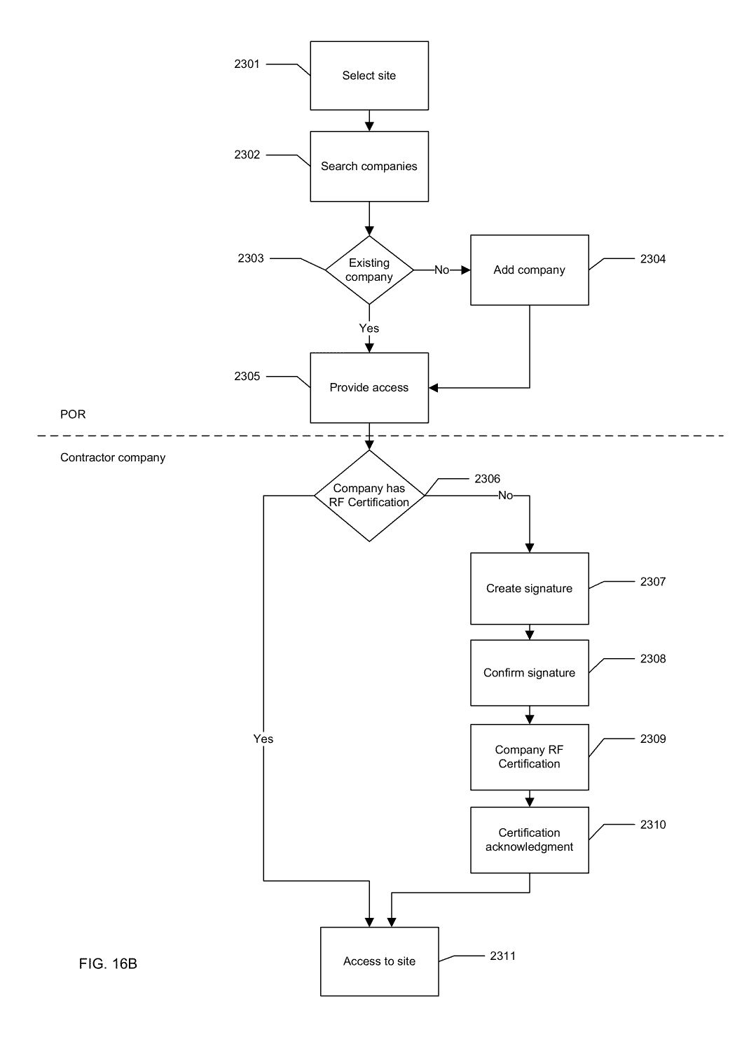

FIG. 16A is a flow diagram of further functionality provided by the Climber/Tower certification module 427 of FIG. 4 which allows a user to provide contractor companies the system functionalities of tower access, training and certification similar to that provided for employees. This functionality addresses the need to provide a Climber/Tower Worker of a subcontractor with the appropriate Site-specific Climber/Tower Safety Sheet and to provide a subcontractor's workers with Worker Climber/Tower Safety Certification.

After a tower is selected at step 2351, the module allows the user to find, in the database, companies (e.g., subcontractors) that are certified who also may have workers who possess: Worker Climber/Tower Safety Certification, Site-specific Climber/Tower Safety Sheet Acknowledgement The system also allows the User to view details about a selected company or to begin the process of adding a new company to the database. At step 2352 the system provides the results of all companies with the closest company presented first and all others in ascending distance from the selected tower. Information regarding the company can be presented, such as: Company name, Company Address, Number of workers with Worker CT Certification, Number of the company workers that possess a valid Site-specific Climber/Tower Safety Sheet, and Number of the company workers that possess a valid Site-specific Climber/Tower Safety Sheet. The quantity represents the number of workers that possesses a valid Site-specific Climber/Tower Safety Sheet. To be considered valid, the Site-specific Climber/Tower Safety Sheet must be of the same version as the current version. The User may also search for a specific company name at step 2352. This system presents an ever-narrowing list of names by conducting a fuzzy match lookup as the User types. For example, as the user begins their typing, the system will return all names that best match the sequence of letters entered so far. The name can be presented along with the alphabetically ascending city and state in parenthesis. The user may also select a specific Company Type at this step. If the user wished to view additional details of any selected company, they can select the View Details option and the system will present additional information from the database related to that company. If the user wishes to add a company to the system, they can select the Add New option. If the user is adding a new company (Step 2354): The user must enter the desired Company's 9 digit Employer Identification Number (EIN) or combination of Sole proprietor's last name, date of birth and last 4 digits of SSN (Social Security Number) or other selected identifier. When the user enters a company identifier such as a Company EIN or Sole proprietor's last name, date of birth and last 4 digits of SSN, they can select the Lookup function to determine whether the company was previously entered into the system. The system can perform an exact match on, for example, Company EIN or Sole proprietor's last name, date of birth and last 4 digits of SSN. If the company is found in the database, an informational message is presented and the contact information fields will be filled with the information contained in the database. If the Company has not been previously entered, the user can create a new entry by entering the name, title, email address, phone numbers, company name and address. When the user is satisfied with their entries, they select Add to record the information in the database.

At step 2355, after the user has selected the desired company and wishes to provide that company access to their Site-specific Climber/Tower Safety Sheets, they select the Provide Company Access option. Selection of the Provide Company Access option causes the system to associate the selected tower with the company (if not already associated) and send an email notification to the company (for example, to a selected authorized officer of the company) alerting them to the potential request for services. The system determines whether the company has not obtained their Company Climber/Tower Safety Certification, or no longer possesses a valid certification status (Step 2356), and if not, the system directs the company or its authorized officer the Company Climber/Tower Safety Certification procedure represented by steps 2357, 2358, 2359, and 2360. A purpose of the Company Electronic Signature page provides reasonable evidence that the intended company is the company that will participate in the Climber/Tower Safety Certification tutorials.

At step 2357, the Company Electronic Signature page is presented to a user, for example, by the user clicking on or following a secure link received by an email sent by the system. The sending of the email with the secure link can also be triggered by a system background task that determines when a company's certification becomes due. In that case, the system automatically sends out a re-certification email with a similar secure link as is sent for a new company. The information text in the email is prefaced with the company's responsible party's name & the Company's name. The Login ID will contain the email address of the recipient. The authorized individual must enter an identifier, for example, the company name and their 9 digit Federal Employer ID or Sole proprietor's last name, date of birth and last 4 digits of SSN. The authorized individual also enters a valid password and reconfirms the password. If the values entered by the authorized individual match those entered by the user, the Company record is created with the Login ID and Password recorded in the database. Upon all fields successfully matching, the system will present the authorized individual with the Electronic Signature Confirmation page represented by step 2358.

A purpose of the Company Electronic Signature Confirmation page is to affirm and record that the user accepts the presented signature as an authorized and binding signature. In the Company Electronic Signature Confirmation screen the system presents the company information as read-only information. It will also “stylize” the first and last name of the authorized individual to simulate an actual handwritten signature. Lastly, it will stylize the first and last name initial as the authorized individual's electronic Initials. The “I accept my electronic signature” option is enabled as is the Cancel option. If the user selects the “I accept my electronic signature” option, the system creates a secure (unique) document id. The document id can be comprised of the following: First Name, Last Name, EIN or Sole proprietor's date of birth and last 4 digits of SSN, and System date and time, Document ID. Document ID is the Document Name and Version number. For example GRFC-V1.7 would indicate CT Certification, version 1.7. This secure document id becomes part of the company's database history and can be used to provide evidence that the authorized company completed the specific training that is/was contained in the referenced document. After acceptance, the system will present the content of the applicable Climber/Tower Safety Certification tutorial and tests as represented by step 2359. The Climber/Tower Safety Certification tutorial and tests can be those discussed above in connection with Table tutorial 320 of FIG. 3. The operation of the tutorial and test is discussed further below.

At the completion of all of the tutorial sections and passing the certification tests, a final signature must be obtained as represented by step 2360. At this step the system presents the individual's name, current date & time and the system generated Secure Document ID created at the beginning of the tutorial process. The individual's previously accepted signature will be created and presented when the Sign button is selected. Selection of the Sign button will present the individual's signature created in the Company Electronic Signature page. After this the user is enabled to access the system as represented by step 2361. For example, the user can be presented with the Continue to Web Site button.

FIG. 16B is a flow diagram of further functionality provided by the RF certification module 429 of FIG. 4 which allows a user to provide contractor companies the system functionalities of site access, training and certification similar to that provided for employees. This functionality addresses the need to provide a RF Trained or General Worker of a subcontractor with the appropriate RF Safety Summary Sheet and to provide a subcontractor's workers with Trained Worker RF Certification.

After a site is selected at step 2301, the module allows the user to find, in the database, companies (e.g., subcontractors) that are certified who also may have workers who possess: Trained Worker RF Certification, Site Specific RF Safety Summary Sheet for General Worker Acknowledgement, and Site Specific RF Safety Summary Sheet for RF Trained Worker Acknowledgement (including Site Specific RF Certification for Trained Worker). The system also allows the User to view details about a selected company or to begin the process of adding a new company to the database. At step 2302 the system provides the results of all companies with the closest company presented first and all others in ascending distance from the selected site. Information regarding the company can be presented, such as: Company name, Company Address, Number of workers with Trained Worker RF Awareness Certification, Number of the company workers that possess a valid Site Specific RF Safety Summary Sheet for RF Trained Worker, and Number of the company workers that possess a valid Site Specific RF Safety Summary Sheet for General Worker. The quantity represents the number of workers that possesses a valid Site Specific RF Safety Summary Sheet. To be considered valid, the Site Specific RF Safety Summary Sheet must be of the same version as the current version. The User may also search for a specific company name at step 2302. This system presents an ever-narrowing list of names by conducting a fuzzy match lookup as the User types. For example, as the user begins their typing, the system will return all names that best match the sequence of letters entered so far. The name can be presented along with the alphabetically ascending city and state in parenthesis. The user may also select a specific Company Type at this step. If the user wished to view additional details of any selected company, they can select the View Details option and the system will present additional information from the database related to that company. If the user wishes to add a company to the system, they can select the Add New option. If the user is adding a new company (Step 2304): The user must enter the desired Company's 9 digit Employer Identification Number (EIN) or combination of Sole proprietor's last name, date of birth and last 4 digits of SSN (Social Security Number) or other selected identifier. When the user enters a company identifier such as a Company EIN or Sole proprietor's last name, date of birth and last 4 digits of SSN, they can select the Lookup function to determine whether the company was previously entered into the system. The system can perform an exact match on, for example, Company EIN or Sole proprietor's last name, date of birth and last 4 digits of SSN. If the company is found in the database, an informational message is presented and the contact information fields will be filled with the information contained in the database. If the Company has not been previously entered, the user can create a new entry by entering the name, title, email address, phone numbers, company name and address. When the user is satisfied with their entries, they select Add to record the information in the database.

At step 2305, after the user has selected the desired company and wishes to provide that company access to their Site Specific RF Safety Summary Sheets, they select the Provide Company Access option. Selection of the Provide Company Access option causes the system to associate the selected site with the company (if not already associated) and send an email notification to the company (for example, to a selected authorized officer of the company) alerting them to the potential request for services. The system determines whether the company has not obtained their Company RF Certification, or no longer possesses a valid certification status (Step 2306), and if not, the system directs the company or its authorized officer the Company RF Certification procedure represented by steps 2307, 2308, 2309, and 2310. A purpose of the Company Electronic Signature page provides reasonable evidence that the intended company is the company that will participate in the RF Certification tutorials.

At step 2307, the Company Electronic Signature page is presented to a user, for example, by the user clicking on or following a secure link received by an email sent by the system. The sending of the email with the secure link can also be triggered by a system background task that determines when a company's certification becomes due. In that case, the system automatically sends out a re-certification email with a similar secure link as is sent for a new company. The information text in the email is prefaced with the company's responsible party's name & the Company's name. The Login ID will contain the email address of the recipient. The authorized individual must enter an identifier, for example, the company name and their 9 digit Federal Employer ID or Sole proprietor's last name, date of birth and last 4 digits of SSN. The authorized individual also enters a valid password and reconfirms the password. If the values entered by the authorized individual match those entered by the user, the Company record is created with the Login ID and Password recorded in the database. Upon all fields successfully matching, the system will present the authorized individual with the Electronic Signature Confirmation page represented by step 2308.

A purpose of the Company Electronic Signature Confirmation page is to affirm and record that the user accepts the presented signature as an authorized and binding signature. In the Company Electronic Signature Confirmation screen the system presents the company information as read-only information. It will also “stylize” the first and last name of the authorized individual to simulate an actual handwritten signature. Lastly, it will stylize the first and last name initial as the authorized individual's electronic Initials. The “I accept my electronic signature” option is enabled as is the Cancel option. If the user selects the “I accept my electronic signature” option, the system creates a secure (unique) document id. The document id can be comprised of the following: First Name, Last Name, EIN or Sole proprietor's date of birth and last 4 digits of SSN, and System date and time, Document ID. Document ID is the Document Name and Version number. For example GRFC-V1.7 would indicate RF Awareness Certification, version 1.7. This secure document id becomes part of the company's database history and can be used to provide evidence that the authorized company completed the specific training that is/was contained in the referenced document. After acceptance, the system will present the content of the applicable RF Certification tutorial and tests as represented by step 2309. The RF Certification tutorial and tests can be those discussed above in connection with Table tutorial 320 of FIG. 3. The operation of the tutorial and test is discussed further below.

At the completion of all of the tutorial sections and passing the certification tests, a final signature must be obtained as represented by step 2310. At this step the system presents the individual's name, current date & time and the system generated Secure Document ID created at the beginning of the tutorial process. The individual's previously accepted signature will be created and presented when the Sign button is selected. Selection of the Sign button will present the individual's signature created in the Company Electronic Signature page. After this the user is enabled to access the system as represented by step 2311. For example, the user can be presented with the Continue to Web Site button.

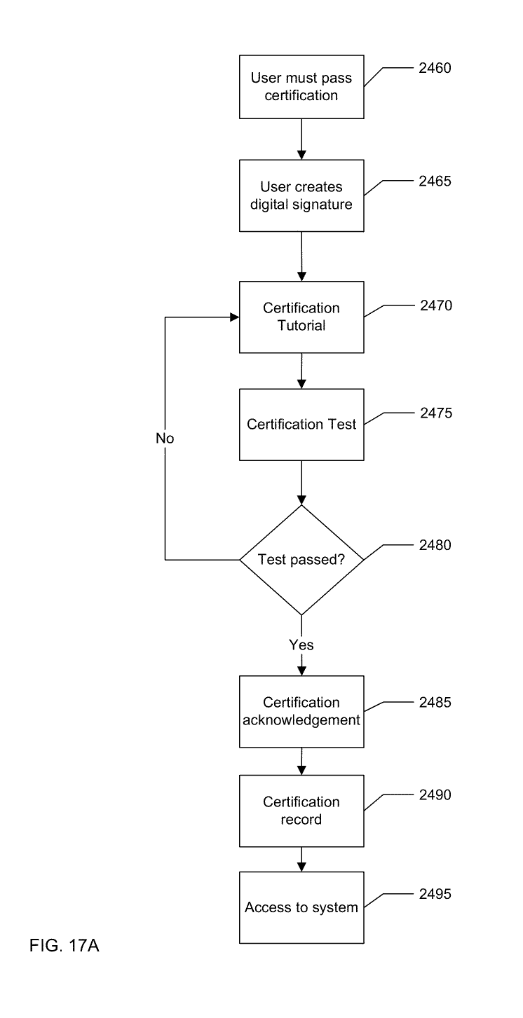

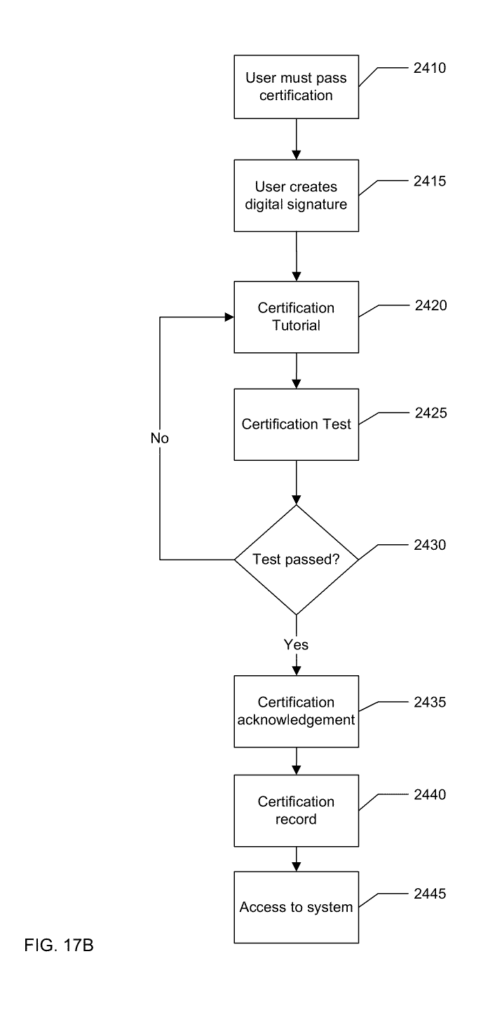

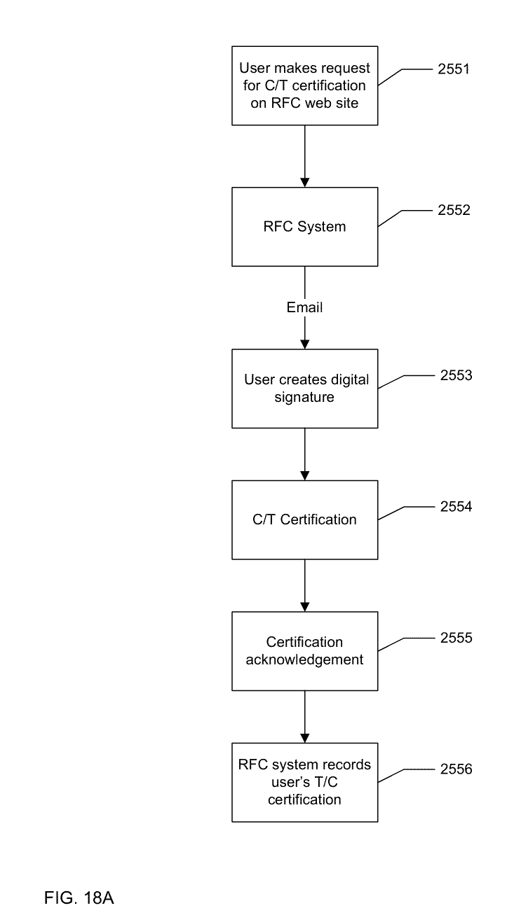

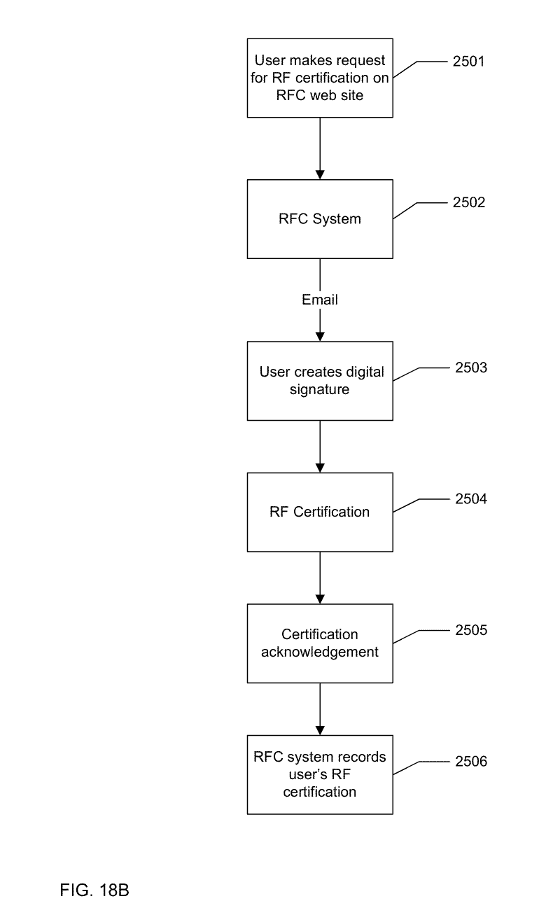

FIGS. 17A and 18A are flow diagrams of a processes for a user to obtain certification which can be implemented by the Climber/Tower Safety Certification module 427 of FIG. 4. For example, this process can be used whenever the system requires a user to have a type of certification as represented by FIG. 17A or at the request of a user as represented by FIG. 18A.

Referring to FIG. 17A, the system determines that a user requires certification which is represented by step 2460. The system then directs the user to the beginning of the process for the appropriate certification. The user then creates a digital or electronic signature as represented by step 2465. That process has been described in connection with step 2256 of FIG. 15A. Next, the user is taken through a certification process as represented by steps 2470, 2475 and 2480. In one embodiment, the certification process starts with the tutorial contained in the Table tutorial 320 of FIG. 3. The content of the certification process can be based upon government safety rules or laws or can be selected by the system operator. In one embodiment, the process is an interactive tutorial. Alternatively, written materials can be provided electronically. The certification process includes presenting a test to the user at the end of the tutorial as represented by step 2475. The test and the questions are stored in the tables 325 and 330 of FIG. 3. At step 2480 the system compares the user's test score with a minimum score on the test that is required in order to obtain the certification. If the user's score is less then the minimum required score, the user is redirect back to step 2470—certification tutorial. If the user passes the test, he must acknowledge his certification (2490) and this is indicated in the database. At step 2490 the system creates a record about the user certification using table 340 of FIG. 3. At step 2495 access to the system is granted to the user and—the user is directed to an initial page such as are implemented by modules 422 and 424 shown in FIG. 4.

Referring now to FIG. 18A, a similar process for a user to obtain a certification at the request of the user is shown. The process can begin with a user making a request for a certification, for example at a public page provided by the system, such as a home page, which is represented by step 2551. The system then directs the user to the beginning of the process for the appropriate certification (2552). The user then creates a digital or electronic signature as represented by step 2553. That process has been described in connection with step 2256 of FIG. 15A. Next, the user is taken through a certification process as represented by step 2554. The content of the certification process can be based upon government safety rules or laws or can be selected by the system operator. In one embodiment, the process is an interactive tutorial. Alternatively, written materials can be provided to the user electronically. The certification process includes presenting a test to the user at the end of the tutorial. A minimum score on the test can be required in order to obtain the certification. That process has been described in connection with steps 2470, 2475 and 2480 of FIG. 17A. The user then must acknowledge his certification (2555) and this is indicated in the database (2556).

FIGS. 17B and 18B are flow diagrams of processes for a user to obtain certification which can be implemented by the RF Certification module 429 of FIG. 4. For example, this process can be used whenever the system requires a user to have a type of certification as represented by FIG. 17B or at the request of a user as represented by FIG. 18B.

Referring to FIG. 17B, the system determines that a user requires certification which is represented by step 2410. The system then directs the user to the beginning of the process for the appropriate certification. The user then creates a digital or electronic signature as represented by step 2415. That process has been described in connection with step 2206 of FIG. 15B. Next, the user is taken through a certification process as represented by steps 2420, 2425 and 2430. In one embodiment, the certification process starts with the tutorial contained in the Table tutorial 320 of FIG. 3. The content of the certification process can be based upon government safety rules or laws or can be selected by the system operator. In one embodiment, the process is an interactive tutorial. Alternatively, written materials can be provided electronically. The certification process includes presenting a test to the user at the end of the tutorial as represented by step 2425. The test and the questions are stored in the tables 325 and 330 of FIG. 3. At step 2430 the system compares the user's test score with a minimum score on the test that is required in order to obtain the certification. If the user's score is less then the minimum required score, the user is redirect back to step 2420—certification tutorial. If the user passes the test, he must acknowledge his certification (2404) and this is indicated in the database. At step 2440 the system creates a record about the user certification using table 340 of FIG. 3. At step 2445 access to the system is granted to the user and—the user is directed to an initial page such as are implemented by modules 422 and 424 shown in FIG. 4.

Referring now to FIG. 18B, a similar process for a user to obtain a certification at the request of the user is shown. The process can begin with a user making a request for a certification, for example at a public page provided by the system, such as a home page, which is represented by step 2501. The system then directs the user to the beginning of the process for the appropriate certification (2502). The user then creates a digital or electronic signature as represented by step 2503. That process has been described in connection with step 2206 of FIG. 15B. Next, the user is taken through a certification process as represented by step 2504. The content of the certification process can be based upon government safety rules or laws or can be selected by the system operator. In one embodiment, the process is an interactive tutorial. Alternatively, written materials can be provided to the user electronically. The certification process includes presenting a test to the user at the end of the tutorial. A minimum score on the test can be required in order to obtain the certification. That process has been described in connection with steps 2420, 2425 and 2430 of FIG. 17B. The user then must acknowledge his certification (2505) and this is indicated in the database (2506).

FIG. 26A is a flow diagram of further functionality which can be provided by the Climber/Tower Safety Certification module 427 of FIG. 4. In general, the method shown in FIG. 26A is an example of how the module allows new users to be added, sends the new user an invitation (e.g., an email) and to begin the certification process if required.

Referring to FIG. 26A, an administrator or existing using can add a new user by enter certain data about the new user, such as a name and email address as represented by step 2651. The system then contacts the new user, for example by sending an email with a link (step 2653). At step 2655, if the link is not activated before it expires, the email is re-sent (step 2657) and others can be notified. If the new user again fails to respond (step 2659) others can again be contacted and the email can be resent again (step 2661).

When the user responds to the invitation, they are taken through a welcome and registration process (step 2662). New users that need to pass certification (step 2663) are directed to a certification process represented by steps 2665 and 2667. This can be the process represented by FIG. 17A. The content of the certification process can be based upon government safety rules or laws or can be selected by the system operator. A test can be presented to the user at the end of the tutorial (step 2667) and minimum score on the test can be required in order to obtain the certification. Then, the user is directed to an initial page such as are implemented by modules 422 and 424 shown in FIG. 4.

Besides the method described above, the system also allows a user (e.g., a worker or a sub-contractor) to initiate their certifications by clicking on a link or activating a button in other screens of the system such as the public web site (step 2551 of FIG. 18A). The system then processes the user request and sends the user an email that contains a link to certification screens (step 2552 of FIG. 18A). By completing the Climber/Tower Safety Certification, the worker also becomes part of the database system and is listed in the system as a “certified worker”. The worker becomes visible for other users of the system seeking a worker with an Climber/Tower Safety Certification. Completion of the Company Climber/Tower Safety Certification allows a company to accelerate a future request for accessing the system by skipping steps 2357-2360 from FIG. 16A. By completing the Company Climber/Tower Safety Certification, the contractor company also becomes part of the system and is listed in the database as a company with Climber/Tower Safety Certification. The Company becomes visible (searchable) for other users of the system seeking a company with Climber/Tower Safety Certification.

FIG. 26B is a flow diagram of further functionality which can be provided by the RF Certification module 429 of FIG. 4. In general, the method shown in FIG. 26B is an example of how the module allows new users to be added, sends the new user an invitation (e.g., an email) and to begin the certification process if required.

Referring to FIG. 26B, an administrator or existing using can add a new user by enter certain data about the new user, such as a name and email address as represented by step 2601. The system then contacts the new user, for example by sending an email with a link (step 2603). At step 2605, if the link is not activated before it expires, the email is re-sent (step 2607) and others can be notified. If the new user again fails to respond (step 2609) others can again be contacted and the email can be resent again (step 2611).

When the user responds to the invitation, they are taken through a welcome and registration process (step 2612). New users that need to pass certification (step 2613) are directed to a certification process represented by steps 2615 and 2617. This can be the process represented by FIG. 17B. The content of the certification process can be based upon government safety rules or laws or can be selected by the system operator. A test can be presented to the user at the end of the tutorial (step 2617) and minimum score on the test can be required in order to obtain the certification. Then, the user is directed to an initial page such as are implemented by modules 422 and 424 shown in FIG. 4.

Besides the method described above, the system also allows a user (e.g., a worker or a sub-contractor) to initiate their certifications by clicking on a link or activating a button in other screens of the system such as the public web site (step 2501 of FIG. 18B). The system then processes the user request and sends the user an email that contains a link to certification screens (step 2502 of FIG. 18B). By completing the Climber/Tower Safety Certification, the worker also becomes part of the database system and is listed in the system as a “certified worker”. The worker becomes visible for other users of the system seeking a worker with an Climber/Tower Safety Certification. Completion of the Company Climber/Tower Safety Certification allows a company to accelerate a future request for accessing the system by skipping steps 2307-2310 from FIG. 16B. By completing the Company Climber/Tower Safety Certification, the contractor company also becomes part of the system and is listed in the database as a company with Climber/Tower Safety Certification. The Company becomes visible (searchable) for other users of the system seeking a company with Climber/Tower Safety Certification.

Various embodiments may be implemented using a combination of both hardware and software.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention. References to a “page” refer to a visual display of information such as a web page or other representation of information presented to a user on a computer display device.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A computerized safety system for managing safety training certification for tower climbing safety at radio transmission towers, comprising:
a database server storing
transmitter information for radio frequency (RF) transmitters located at transmission towers obtained from a plurality of wireless telecommunication companies and indexed by tower, and
records of users and their tower climbing training certification status; and
an application server comprising
a processor, and
a memory storing instructions for execution by the processor, the instructions comprising:
a site search module configured to define search parameters, accept search criteria selected by a user, transmit a search request based upon selected search criteria, and provide search results to the user,
a certification module configured to
identify users in the database based upon their tower climbing training certification status,
provide a Site Specific Climber Tower (C/T) Safety Summary Sheet pertaining to a transmission tower to only users having a predetermined tower climbing training certification status, and
create a record in the database that the Site Specific C/T Safety Summary Sheet pertaining to the transmission tower was provided to the user.

2. The system of claim 1, further comprising an audit module configured to monitor safety violations, accident history, and compliance status pertaining to a transmission tower.

3. The system of claim 1, wherein the certification module is further configured to provide tutorials to users and record in the database whether that the training was completed.

4. A method for operating a computerized safety system for managing safety training certification for communication towers, comprising:
receiving data regarding the communication towers from a plurality of sources;
maintaining a database with the received data;
calculating power densities for radio frequency (RF) antennas at a communication tower in the database;
identifying users in a database based upon their training certification status;
defining search parameters;
accepting search criteria selected by a user;
transmitting a search request based upon selected search criteria;
providing search results to the user;
providing with the search result a Site Specific Climber/Tower (T/C) Safety Summary Sheet pertaining to the communication tower generated from the data regarding the communication towers to only users having a predetermined training certification status, the Site Specific C/T Safety Summary Sheet including the maximum permissible exposure map; and
creating a record in the database that the Site Specific C/T Safety Summary Sheet pertaining to the transmission site was provided to the user.

5. The method of claim 4, wherein the data received from a plurality of sources is used to define graphic representations of the tower.

6. The method of claim 4, further comprising providing access to the database to a user based upon a classification of the user.

7. The method of claim 6, wherein the database includes a designation of representatives and properties of property owners and access to data in the database by the representatives is limited to data associated with existing sites on the properties associated with the representatives.

8. The method of claim 6, wherein a representative of a network operator can view data associated with existing and proposed sites of that network operator.

9. The method of claim 6, wherein access to data in the database is limited such that a local regulator's access is limited to existing and proposed sites within the local regulator's jurisdiction, and wherein access to data in the database is limited such that a member of the public is limited to existing and proposed towers within a defined radius from a residence of the member of the public.

10. The method of claim 6, wherein access to the data associated with an existing tower can be granted to identified individuals assigned to perform work at that tower.

11. A method for operating a computerized safety system for managing safety training certification for tower climbing safety relating to radio transmission sites and for maintaining data relating to those sites, the method comprising:
maintaining a database on a server of information relating to transmission sites with antenna structures having one or more antennas;
providing certification to users;
identifying users in the database based upon their training certification status;
defining search parameters;
accepting search criteria selected by the users;
transmitting a search request based upon the selected search criteria;
providing search results to the users;
providing a Site Specific Climber/Tower (C/T) Safety Summary Sheet pertaining to the transmission site to only users having a predetermined training certification status; and
creating a record in the database that the Site Specific C/T Safety Summary Sheet pertaining to the transmission site was provided to the user.

12. The method of claim 11, further comprising using the data from a plurality of sources to provide users with tower accident tracking history.

13. A method for operating a computerized safety system for managing safety training certification for tower climbing safety relating to radio transmission sites and for maintaining data relating to those sites using a computer network system, the method comprising:
maintaining a radio frequency (RF) site database on a server comprising locations of the sites, camera images of the sites, information regarding physical layouts of the sites, antenna system (AS) information for antenna systems located at the sites including broadcast frequencies and powers, data for site specific RF Safety Summary Sheets for the sites, the data for site specific RF Safety Summary Sheets including graphic representations of calculated power densities for antennas in the database at the sites, and data for site specific climber/tower (C/T) Safety Summary Sheets for the sites, the data for site specific C/T Safety Summary Sheets including hazardous conditions related to tower climbing;
determining the calculated power densities for antennas in the database and generating the graphical representations of the calculated power densities when a change is made to the sites and updating the RF site database with the determined values and graphical representations;
maintaining a database of user certification information and receipt by users of RF Safety Summary Sheets by tracking certifications completed and acknowledged by users and RF Safety Summary Sheets acknowledged as received by users;
maintaining a database of user certification information and receipt by users of C/T Safety Summary Sheets by tracking certifications completed and acknowledged by users and C/T Safety Summary Sheets acknowledged as received by users;
providing training and testing via the computer network system to users to establish certification of the users and updating the database of user certification information to indicate the results of the training and testing;
providing search results to users including defining search parameters, accepting search criteria selected by users, transmitting search requests based upon selected search criteria, and transmitting search results to users; and
controlling access by users to site specific RF Safety Summary Sheets and to site specific C/T Safety Summary Sheets based upon the certification of users indicated in the database of user certification information.

14. The method of claim 13, further comprising providing access to the RF site database to a user based upon a classification of the user stored in the database of user certification information.

15. A method for providing access to climber/tower safety information relating to a communication tower while a worker is at the communication tower, comprising:
reading a machine readable indicia located at a communication tower with a mobile communication device; and
the mobile communication device initiating communication with a climber/tower safety system.

16. The method of claim 15 wherein the mobile communication device initiates communication with the climber/tower safety system by requesting over a communication network the safety information of the tower associated with the machine readable indicia.

17. The method of claim 16 wherein the mobile communication device receives the safety information of the tower associated with the machine readable indicia.

18. The method of claim 15 wherein the mobile communication device initiates communication with the climber/tower safety system by placing a telephone call to a call center associated with the climber/tower safety system.

19. The method of claim 15 wherein the mobile communication device initiates communication with the climber/tower safety system by transmitting its telephone number to the radio transmission safety system.

20. The method of claim 19 wherein the mobile communication device receives a call from a call center associated with the climber/tower safety system.

21. The method of claim 15 wherein the mobile communication device initiates communication with the climber/tower safety system by using information in the machine readable indicia to down load the safety information of the tower associated with the machine readable indicia.

22. The method of claim 15 wherein the machine readable indicia is a quick response (QR) code.

23. The method of claim 21 wherein the safety information of the tower associated with the machine readable indicia indicates tower safety elements, and the mobile communication device displays that information overlaid on images captured through the device's camera.

24. A method for operating a climber/tower safety system to provide access to climber/tower safety information relating to a communication tower while a worker is at the communication tower, the method comprising:
placing a machine readable indicia at a communication tower, the machine readable indicia being readable by a wireless mobile communication device and including data which identifies the tower;
receiving a communication from a wireless mobile communication device, the communication including the data which identifies the tower;
in response to receiving the communication, transmitting the safety information of the tower associated with the machine readable indicia.

25. The method of claim 24 wherein the communication from the mobile communication device is a telephone call to a call center associated with the climber/tower safety system and the telephone number of the call center is indicated in data in the machine readable indicia.

26. The method of claim 24 wherein the communication from the mobile communication device includes the telephone number of the mobile communication device and the climber/tower safety system automatically calls the telephone number.
